(19) United States
(12) Patent Application Publication
(10) Pub. No.: US 2007/0149232 A1
(43) Pub. Date: Jun. 28, 2007

(54) Information transmission with energy budget management

(76) Inventor: Manfred Koslar, Berlin (DE)

Correspondence Address: Ware Fressola Van Der Sluys & Adolphson, Bradfort Green Building 5, 755 Main St., P.o. box 224, Monroe, CT, 06468, US

(21) Appl. No.: 10/565,285

(22) PCT Filed: Jul. 26, 2004
(86) PCT No.: PCT/EP04/08460

§ 371 Date: Jun. 8, 2006

(30) Foreign Application Priority Data
Jul. 24, 2003 (DE) 10333855.6
Oct. 15, 2003 (DE) 10349191.0

(51) Int. Cl. H04B 1/04; H04B 7/00

(52) U.S. Cl. 455/522; 455/127.1

(57) ABSTRACT

A receiver-specific regulation of the transmission energy of a symbol to be transmitted is effected by adaptation of the symbol duration or by adaptation of the number of bits transmitted with the symbol or by both measures in combination, in each case using a respective predetermined transmission power. As a result each of the measures provided for adjustment of the transmission energy effects adaptation of the symbol duration per bit, that is to say the ratio of the symbol duration to the number of bits contained therein. What is crucial for adaptation in each case is observing, or, in an alternative form of the method, falling below an upper limit value in respect of an error recognition rate associated with the respective receiver when using the predetermined transmission power. The transmission method according to the invention therefore, to clearly indicate the distinction from power management methods, can also be referred to as energy management in the form of bit duration management (BDM). That is a significant difference in relation to previously known methods and this signifies a completely new network organization which is referred to as energy budget management.

### CROSS REFERENCE TO RELATED APPLICATIONS

This application is for entry into the U.S. national phase under §371 for International Application No. PCT/EP04/08460 having an international filing date of Jul. 26, 2004, and from which priority is claimed under all applicable sections of Title 35 of the United States Code including, but not limited to, Sections 120, 363 and 365(c), and which in turn claims priority under 35 USC §119 to German Patent Application No. 103 33 844.6 filed on Jul. 24, 2003, and German Patent Application No. 103 49 191.0 filed on Oct. 15, 2003.

### FIELD OF THE INVENTION

The present invention concerns a method of transmitting a plurality of symbols each with at least one bit from a transmitter to at least one receiver using at least one channel and a method of organizing a network wherein for each transmission of a plurality of symbols each having at least one bit from a transmitter to at least one receiver using at least one channel symbols are transmitted. The invention further concerns a transmitter, a receiver and a transmitting and receiving system for carrying out the method.

### BACKGROUND OF THE INVENTION

Communication engineering is generally concerned with the transmission of information from a communication source, a transmitter, to the communication destination, a receiver. The medium used for transmission is referred to as a channel.

The various channels which can be used in communication engineering for the transmission of items of information between a transmitter and a receiver differ substantially from each other. Wired connections are distinguished on the one hand by little interference and on the other hand by an only limited bandwidth. On the one hand a great deal of interference and many echoes and on the other hand a relatively great bandwidth are characteristic of wireless connections. In addition there are glass fiber connections involving extremely great bandwidths and low levels of interference.

For example the bandwidth, the maximum transmission power and time are defined as channel resources. Instead of that for example spectral power density or spectral energy density is defined in specific uses.

Economical use of the channel resources is sought to be achieved by the joint use thereof for as many connections as possible. In particular, in the case of large networks such as local telephone networks, in the sense of making as extensive use as possible of the available channel capacity, it has not proven to be appropriate to allocate a fixed part of the available channel capacity to each subscriber in the context of a line-switched connection. In previously known transmission methods, channel capacity is distributed to the individual subscribers in an LAN, WLAN, GSM network, UMTS network, telephone network, and so forth, using various multiplexing procedures.

All multiplex methods involve dividing up the available channel capacity. In the TDMA (Time Division Multiple Access) and FDMA (Frequency Division Multiple Access) methods that division is effected at the physical level insofar as time slots or frequency bands are set up, which are allocated to different users. In addition there are CDMA (Code Division Multiple Access) systems which implement that division by coding insofar as various codes which are orthogonal in specific implementations are associated with each user so that the message intended for one receiver can be separated from the messages for other receivers, when the respective code is known at the receiver end.

The planning and development of a network are implemented in consideration of the various channel properties. For example optimization of the cell size in a GSM network is effected in dependence on the geographical position and thus the existing subscriber density and the multipath conditions. In that respect planning processes are geared to what is referred to as the worst case scenario. In other words, a maximum distance in the network or a minimum reception power (sensitivity) is predetermined. The network is so dimensioned that all subscribers can receive the same symbol rate.

That ensures that even those receivers for which the worst transmission conditions apply can still be afforded a minimum level of transmission quality. Transmission quality can be quantified for example on the basis of an error recognition rate, for example a bit error rate (BER), at the receiver. In the context of this application the different kinds of error rates which are known to the men skilled in the art are summarized by the generic term error recognition rate.

The state of the art in the field of channel management will now be described by reference to some examples.

a) WLAN Standard 802.11 b

In accordance with this Standard for local wireless transmission networks (wireless local area network, WLAN) for the transmission of data in the ISM band at 2.45 GHz:

CDMA sequences are used in order to be robust in relation to multipath propagation,

optionally RAKE receivers are used in order to provide for optimum focusing of the energy of the individual multiple paths,

error-correcting codes are used in order to decrypt the correct information in spite of individual errors in the data stream, and

various modulation modes (BPSK, QPSK, CCK) are used in order to transmit the maximum data rate or a data rate complying with the requirements involved, depending on the respective quality of the channel.

Thus, for individual peer-to-peer connections within a network, depending on the respective quality of the available transmission channel, it is possible to adapt the data rate to the factors involved so that connections of differing speeds can be dynamically set up in a network.

In regard to the properties of the transmission channel it is thus possible either to transmit the maximum data rate of 11 Mbps or to use an additional convolution code and to drop to 5.5 Mbps, or, in the case of even worse channels, to avoid higher-grade CCK modulation and to transmit only with QPSK or even only with BPSK so that the data rate drops to the symbol rate used during transmission (1 MSps) and only 1 Mbps is still possible. In that respect various modulation modes are used while retaining the original spread of the data symbol. Subscribers who suffer from excessively great attenuation because of an excessively great distance away can no longer be reached. Furthermore the capacity of the channel is thus not put to optimum use.

b) UMTS

This mobile radio standard (Universal Mobile Telecommunication Service) has similar properties to the Standard 802.11 b. In the mobile radio area a large number of subscribers have access to a base station. For that purpose a CDMA (Code Division Multiple Access) method is used, in which each subscriber has dynamically allocated a fixed code. In addition the antennae of the base station are so arranged that various sectors are produced, which have only slight influence on each other (“space diversity”).

UMTS has power management which tries to keep approximately equal the power of all subscribers, which is received in the base station. That is of crucial significance in terms of the separation of the CDMA channels. At the same time the endeavor is to match all subscribers in a network to a lowest possible level of transmission power.

The use of long CDMA sequences and rake receivers permits that system a certain degree of robustness in relation to strong multipath propagation. Nonetheless the cell size here is greatly limited in comparison with the GSM system. The bandwidth used is relatively great by virtue of a spread method employed. Nonetheless each subscriber has only a comparatively greatly reduced data rate, by virtue of the CDMA sequences used, which represent a data symbol.

Spreading is effected by a procedure whereby, in relation to the predetermined bandwidth, short physical symbols are defined, which are referred to as chips. The transmitted symbols carrying information or subscriber-specific CDMA sequences extend over a plurality of chips.

The system constructed in that way is rigid and guarantees the maintenance of a minimum transmission quality for each subscriber of a cell. The fact that this is no longer sufficient in modern networks was however something of which the developers were aware so that here dynamic configurational options were additionally incorporated.

A particularity of the UMTS system is to permit channel bundling. In that case a plurality of logical channels are allotted to an individual user. So that the user does not have to receive in parallel a plurality of CDMA sequences, shortened sequences are used here. The data rate is increased in that way. In that fashion a higher data rate can be offered to what are referred to as power users, in return for a corresponding fee.

On the other hand the robustness of data transmission also falls with a data rate which is increased in that way. The increased data rate is therefore only available in respect of channels which have a sufficiently good quality, that is to say a low noise power. In addition the levels of interference in relation to other users increase and management complication and expenditure rises tremendously because it is only possible to use specific channels for bundling, which must all contain the new abbreviated code. The decisive point however is that the channel resources present are not put to optimum use here.

DE 199 37 706 A1 discloses a transmission method with frequency and time spreading at the transmission end. In this transmission method which is also referred to as a multidimensional multiple access method (MDMA), the information symbols to be transmitted are subjected at the transmitter end to frequency spreading and time spreading. In addition a different transmission power can be allotted to the individual subscribers. The reception signals are unspread at the receiver end. The respective spreading effects and thus the system gain can be adaptively matched to the required transmission quality and the currently prevailing channel properties. The extent of time spreading can be implemented when making a connection between a base station and a subscriber station in dependence on reference pulses which serve to ascertain the channel properties.

MDMA makes it possible to be adapted to any requirement within a network and each subscriber and the quality demands thereof. MDMA therefore represents a machine which technically can be used to provide for optimum supply to each subscriber.

That on its own however is still not enough. The question which arises is this: How must a network be managed so that the valuable benefits for the users such as data rate, range, error protection, robustness and so forth can be offered in the optimum fashion? In other words, how is the machine to operate in an organizational fashion in order to convert the flexibility of MDMA into an economic advantage?

Therefore the object of the present invention is to provide a method of transmitting at least one symbol from a transmitter to at least one receiver, which affords a data rate which is as high as possible according to the transmission condition between the transmitter and the respective receiver. Following therefrom as a further aspect of the technical object of the invention is the provision of a method of organizing a network which affords any subscriber within a network a data rate which is as high as possible according to the transmission conditions between the transmitter and the respective receiver and which in that respect better utilizes the available channel resources.

### SUMMARY

In accordance with a first aspect of the invention there is proposed a method of transmitting a plurality of symbols each having at least one bit from a transmitter to at least one receiver using at least one channel and a predetermined transmission power,

wherein the symbols are transmitted with a receiver-specific transmission energy which on the part of the receiver results in the reception of the symbol with a reception energy which corresponds to an upper limit value associated with the receiver or a lower value of an error recognition rate, and

wherein to achieve the receiver-specific transmission energy and at the same time a bit rate which is as high as possible in dependence on the currently prevailing transmission conditions between the transmitter and the receiver the symbol duration, or the number per symbol of transmitted bits, or the symbol duration and the number per symbol of transmitted bits is adapted.

In accordance with a second aspect of the invention there is proposed a method of organizing a network wherein for each transmission of a plurality of symbols each with at least one bit from a transmitter to at least one receiver using at least one channel and a predetermined transmission power the symbols are transmitted

with a receiver-specific transmission energy which on the part of the receiver leads to the reception of the symbol with a reception energy which corresponds to an upper limit value associated with the receiver or a value of the error recognition rate occurring, which is lower in comparison with the upper limit value,

wherein in dependence on the currently prevailing transmission conditions between the transmitter and each individual receiver to achieve the receiver-specific transmission energy and at the same time a bit rate which is as high as possible the symbol duration, or the number per symbol of transmitted bits, or the symbol duration and the number per symbol of transmitted bits is adapted.

The two proposed methods are based on the same invention. The method of the invention in accordance with the first aspect thereof, referred to hereinafter as the transmission method according to the invention, sets forth a technical rule for data transmission between a transmitter and at least one receiver. The use of that technical rule in a network for each transmission of a plurality of symbols between a transmitter and at least one receiver forms, based thereon, a technical rule for the organization of the network in accordance with the method set forth in the second aspect of the invention. The latter method is also referred hereinafter as the network organization method according to the invention.

The use of the transmission method of the invention can also be effected without using the network organization method according to the invention, insofar as the transmission method according to the invention is not used in every transmission.

It will be appreciated that the use of the network organization method according to the invention presupposes the use of the transmission method. For, the network organization method concerns any data transmission in the network. The use of the network organization method permits a maximum in terms of efficiency increase, as is explained in detail hereinafter.

Some terms used hereinafter will be explained in greater detail hereinafter, for better understanding of the invention.

The term symbol in accordance with the invention is used to denote a signal representing a logic symbol unless otherwise stated. A logic symbol can contain one or more bits.

The transmission of symbols with a receiver-specific transmission energy means that basically the transmission energy is determined individually for each individual receiver. In accordance with the invention determination of the transmission energy is effected with the proviso that on the part of the receiver reception of the symbol takes place with a reception energy which corresponds to an upper limit value associated with the receiver or a lower value in respect of an error recognition rate.

That does not exclude the same transmission energy being determined for a group of a plurality of receivers, if for example identical current transmission conditions apply for that group of receivers at approximately the same distance from a transmitter.

The term predetermined transmission power, as a distinction from known power management methods, is used to denote a transmission power which is not variable in the context of the methods according to the invention and which is maintained on a time average. If in addition or alternatively an upper limit in respect of peak power is predetermined, that is maintained in the context of the methods according to the invention. It is however also possible that the transmission power presetting is altered externally, whereupon the methods according to the invention react accordingly by adaptation of the symbol duration or the number of bits per symbol or by adaptation of both parameters. Various embodiments concerning the transmission power presetting are explained hereinafter.

The currently prevailing transmission conditions are defined by all parameters which influence the present receiver-end error recognition rate. An influence on the transmission conditions is formed for example by the distance between the transmitter and the receiver (distance attenuation), multipath attenuation and interference effects resulting therefrom at the receiver, interference disturbances for example from adjacent transmitters and noise, shadowing effects due to obstacles in the signal path, channel interference effects and system interference effects, as well as the modulation mode used and the time duration of the symbols.

The upper limit value of an error recognition rate which is used can be for example a value of a bit error rate (BER), a frame error rate (FER) or a block error rate (BLER) or any equivalent value with the significance of an error recognition rate.

The association of a limit value of an error recognition rate with a receiver arises for example from a maximum error recognition rate guaranteed compatible with the user of the receiver, or a service type linked to the data transmission between the transmitter and the receiver (telephone conversation, e-mail, multimedia data transmission, data transmission in the context of a security use etc.).

The expression highest possible data rate is used to denote that data rate which is the highest possible when using the predetermined transmission power and the receiver-specific transmission energy per symbol while maintaining the maximum error recognition rate associated with the receiver. This means that the data rate can vary from one receiver to another, in contrast to previously known methods. That is described in greater detail hereinafter with reference to the Figures.

The solution according to the invention is firstly considered in greater detail hereinafter before embodiments by way of example are described.

The transmission method of the invention moves away from the known power regulation methods (power management). Inter alia for example the known GSM or CDMA methods control the power of the transmitter. That is economically inefficient for a network operator. For, regulation of the transmission power in the context of power management means that the channel capacity available to a network operator cannot be put to optimum use. Furthermore the present invention is based on the consistent transposition of the realization that, for achieving an upper limit value in respect of an error recognition rate on the part of the receiver it is not the reception power but the reception energy per bit that is decisive.

In accordance with the invention therefore it is proposed that a receiver-specific regulation of the transmission energy of a symbol to be transmitted is effected by adaptation of the symbol duration or by adaptation of the number of bits transmitted with the symbol or by both measures in combination, in each case using a respective predetermined transmission power. As a result each of the measures provided for adjustment of the transmission energy effects adaptation of the symbol duration per bit, that is to say the ratio of the symbol duration to the number of bits contained therein. What is crucial for adaptation in each case is observing, or, in an alternative form of the method, falling below, an upper limit value in respect of an error recognition rate associated with the respective receiver, when using the predetermined transmission power, as well as achieving a data rate which is as high as possible. The transmission method according to the invention, to clearly indicate the distinction from power management methods, can also be referred to as energy management in the form of bit duration management (BDM). That is a significant difference in relation to previously known methods and this signifies and permits a completely new network organization.

On the basis of bit duration management the network organization method according to the invention permits more efficient use of the channel capacity available to a network operator. In a network the aim is to supply a plurality of subscribers with a given amount of information in a given period of time. With a predetermined transmission power the given period of time requires an energy budget which is available in total for all subscribers. The network organization method according to the invention optimizes each channel in receiver-specific manner, more specifically in such a way that the energy required to achieve the predetermined error recognition rate and a data transmission which is as fast as possible, that is to say a data rate which is as high as possible, is allocated to each symbol intended for a subscriber. That provides that, in comparison with known network organization methods, either a larger amount of information can be transmitted or more subscribers can be supplied.

That is not successfully attained by regulation of the transmission power because a reduction in the transmission power below the transmission power resetting value in the context of power management does not fully use the resource of transmission power and therewith the available channel capacity. Full utilization is successfully achieved only when observing the transmission power presetting.

The network organization method according to the invention thus uses the parameters available to the network operator as an energy budget, namely transmission power and time, in an improved manner. The network organization method of the invention is therefore also referred to hereinafter as energy budget management (EBM).

Embodiments by way of example of the methods according to the invention are described in greater detail hereinafter. As the transmission method forms so-to-speak the elementary cell of the network organization method, the embodiments described by way of example hereinafter relate both to the transmission method and also to the network organization method of the invention.

Each of the three proposed measures for adapting the transmission energy which cause a change in the symbol duration per bit corresponds according to the invention to an independent transmission method. A combination of the adaptation alternatives is advantageous but not necessary.

In a first embodiment of the transmission method according to the invention it is therefore provided that solely the symbol duration is adapted. A second embodiment provides that solely the number of bits per symbol is adapted. A third embodiment provides that the number of bits per symbol and the symbol duration are adapted at the same time.

Further embodiments by way of example of the transmission method according to the invention provide a selection step in which a selection is made between two or three of the stated adaptation options: a fourth embodiment uses selectively solely adaptation of the symbol duration or solely adaptation of the number of bits per symbol. A fifth embodiment uses selectively solely adaptation of the symbol duration or adaptation of the symbol duration and at the same time of the number of bits per symbol. A sixth embodiment uses selectively solely adaptation of the number of bits per symbol or adaptation of the symbol duration and at the same time the number of bits per symbol. A seventh embodiment uses selectively solely adaptation of the symbol duration or solely adaptation of the number of bits per symbol or adaptation of the bit duration and at the same time the number of bits per symbol.

Preferably in a further embodiment a change can be implemented between a plurality of or all of the above-mentioned embodiments.

Some embodiments concerning the transmission power presetting are discussed hereinafter.

In an embodiment of the invention the transmission power and/or electrical field strengths and/or magnetic field strengths and/or spectral power densities are at a maximum in channel-specific manner on time average and within the limits of admissible power radiation. The admissible transmission powers and/or electrical field strengths and/or magnetic field strengths and/or spectral power densities are predetermined by regulatory authorities. In the case of the network organization method according to the invention, energy budget management, maximum utilization of the available energy budget is achieved in that way. The time average relates to those time segments whose reciprocal is markedly less than the bandwidth.

In a further embodiment on time average the transmission power is at a maximum within the limits of the technical design of the transmitter. If it remains below the admissible power, the maximum of the technically possible utilization of the energy budget available to the transmitter is achieved in that way.

In a further embodiment the transmission power can be preset. The change in the transmission power presetting represents an external intervention in the procedure of the method according to the invention. For example, a selection option in respect of the transmission power presetting can be provided for the user of a mobile terminal, in the context of this embodiment. In that way the user can adjust the transmission power according to his wishes, for example to keep the radiation of the device in an environment which is susceptible to interference, as low as possible. Then, with the transmission conditions remaining the same, a reduction in the transmission power presetting causes a reduction in the maximum data rate which can be achieved as, in the transmission procedure, to achieve the transmission energy, the symbols are transmitted with a greater symbol duration or with a correspondingly smaller number of bits or both.

Described hereinafter are embodiments which concern the operation of ascertaining the required transmission energy.

In a further embodiment there is provided a step for ascertaining a currently prevailing value of the reception energy with a given transmission energy. For example an RSSI measurement (radio signal strength indicator) in respect of the received power can be carried out on the part of the receiver and a signal dependent on the measurement result can be transmitted back to the transmitter.

Alternatively or in addition there can be provided a step for ascertaining a currently prevailing value of the error recognition rate at the transmitter or receiver. In that case the error rate can be ascertained by determining the number of errors within a received data frame. Alternatively the error recognition rate can be ascertained by averaging the number of errors in a plurality of data frames. Furthermore the error recognition rate can be ascertained by means of the number of negative receipt signals of the receiver over a predetermined period of time. The error recognition rate is for example a bit error rate (BER), a block error rate (BLER) or a frame error rate (FER). Frequently used redundant codings and repetition strategies are included therein.

In a further embodiment adaptation of the symbol duration is effected in dependence on the currently prevailing value of the error recognition rate at the receiver end or on a currently prevailing value, at the receiver end, of the noise power density.

In a further embodiment the receiver communicates to the transmitter the currently prevailing error recognition rate or the currently prevailing value of the noise power density. Alternatively or in addition the transmitter estimates the currently prevailing error recognition rate at the receiver end or the currently prevailing value of the noise power density.

In a further embodiment the symbol duration or the number of bits contained in a symbol or both is re-adjusted dynamically in dependence on currently prevailing transmission conditions between the transmitter and the receiver, in an existing connection or an ongoing data traffic, without the connection or the data traffic being interrupted. In other words, setting of the symbol duration is effected not only when making the connection but also during the existing connection, and more specifically preferably transparently for the receiver. The change in symbol duration can be effected in respect of time continuously, alternatively quasi-continuously, or alternatively at predetermined time intervals, during the connection.

In a preferred embodiment the symbol duration is individually adapted in channel-specific fashion, that is to say on each channel used. In particular it is possible in that way to send to a receiver to which symbols are transmitted on a plurality of channels, symbols which are adapted in respect of their duration individually on each channel in accordance with the transmission conditions there.

In an embodiment the symbol duration is limited to short symbol duration values in channel-specific manner solely by the bandwidth of the channel. That provides a particularly wide range of values for varying the symbol duration. The symbol duration can be determined from a continuous spectrum of values, or alternatively from a discrete spectrum of values, in which respect the discrete spectrum of values contains the integral multiples of a symbol duration which is the shortest possible in channel-specific manner.

In a preferred embodiment the symbol duration T_{symbol} is determined at the transmitter end in accordance with the following formula:

$${T}_{symbol} = \frac{{E}_{min} \cdot {( r / {r}_{0} )}^{α}}{{P}_{send}} \qquad ( 1 )$$

wherein Eₘᵢₙ is the reception energy which corresponds to the upper limit value of the error recognition rate, associated with the receiver, P_{send} is the maximum transmission power, r is the distance between the transmitter and the receiver, r₀ is a reference distance and α is a propagation coefficient.

Described hereinafter are embodiments which concern adaptation of the number per symbol of transmitted bits or the selection of a symbol type.

In a further embodiment of the invention selection of the number per symbol of transmitted bits is effected in dependence on the currently prevailing value of the error recognition rate at the receiver end or a currently prevailing value at the receiver end of the noise power density.

Preferably the number per symbol of transmitted bits is adapted in channel-specific manner. That can mean that a receiver receives different symbol types on different channels within a connection. In that way the data rate on each channel can be individually optimized.

In a further embodiment adaptation of the number per symbol of transmitted bits is effected when a symbol duration which is very short in channel-specific terms is already being used. That saves on control communication between transmitter and receiver for communicating the symbol type to be used, for as long as possible.

In a further embodiment a symbol type with the highest possible number of bits is selected for transmission, which at the receiver end does not cause the upper limit value of the error recognition rate to be exceeded.

Embodiments concerning various transmission alternatives are described hereinafter.

In a further embodiment the symbols are respectively transmitted divided up onto a sequence of chips. In that case the symbols can be spread in respect of frequency insofar as they are modulated with a noise sequence (true noise) or a pseudo-noise sequence, the noise or pseudo-noise sequence being known to the receiver. Preferably the noise or pseudo-noise sequence is dynamically adapted to the selected symbol duration. That can be effected for example by a procedure whereby the first chips are always removed from a long m-sequence so that in total they afford the symbol duration.

Alternatively it is possible to use CDMA sequences instead of the pseudo-noise sequences so that a plurality of connections can be formed in parallel relationship.

Maximum utilization of the available channel resources is achieved in relation to the frequency axis when the symbols are transmitted in such a way that the available channel bandwidth is fully used. Preferably therefore the symbols are transmitted in a condition of being frequency-spread.

Chirp signals show that long symbols do not necessarily signify a small bandwidth. In a particularly preferred embodiment the symbols are therefore transmitted in the form of a chirp signal. In that case the long symbols can be replaced by chirp signals which are of the same duration. In that case the product of time duration and transmission power is identical for both pulse forms, that is to say the energy is the same. The chirp signals however represent frequency modulation which in the simplest case extends linearly but generally can assume any, preferably either monotonically rising or monotonically falling function configurations and which can extend over the entire predetermined bandwidth. In that way the signals are spread in respect of frequency.

In a further embodiment the chirp signals of the transmitter, which are intended for a respective receiver, can be mutually superimposed in respect of time. In that case preferably the total of the amounts of power, emitted in a moment in time, of the mutually superimposed chirp signals, is equal to the maximum admissible transmission power on the channel.

The above-mentioned signal spreading effect gives rise to a spreading gain which is helpful for channels which suffer from very severe multipath propagation and/or additional interference signals. In that case the quality of the received signals is heavily dependent on the selected spreading of the signal. Energy budget management directly involves that value because the maximum bandwidth can always be used. Accordingly spreading and at the same time symbol energy increase with an increasing time duration of the pulses.

The energy contained in the spread symbol can be put to optimum use if suitable correlation receivers are used, for example if there is a suitable matched filter in the receiver, which has to be dynamically adapted.

Alternatively, in the case of the long symbols it is also possible to superimpose an FDMA method so that the available bandwidth is divided and the user addressed is allocated only a small part of the bandwidth, which corresponds to the length of the respective data signal. It would then be possible for two or more FDMA channels to be operated in parallel.

In that respect the dynamics of the transmitter are of crucial significance as, upon division into FDMA channels, at the same time the above-discussed case with poor channel conditions is allocated a smaller bandwidth and therefore the optimum symbols are longer and a channel with good conditions is allocated in parallel shorter symbols and thus a greater bandwidth.

It is found here that the energy budget management according to the invention can be linked to practically any modulation mode and any access method.

In a further embodiment a multiplexing method, preferably a TDMA method, is used on a channel as soon as the transmission load of the channel allows. In that way it is possible to guarantee better utilization of the channel capacity for a channel which is associated with a receiver with good transmission conditions and by way of which therefore the items of information to be transmitted can be transmitted in only a short time. In that situation the optimum symbol energy is determined by the error recognition rate for various modulation modes being considered and by that modulation mode being selected, with which the required transmission quality is just still ensured. At the same time that provides for the selection of that higher-stage modulation with which the data can be transmitted as quickly as possible so that the channel capacity involved is put to optimum use. In that situation the symbol duration is not altered as it is already reduced to the minimum value corresponding to the reciprocal of the bandwidth.

In a preferred embodiment the transmitter is a mobile terminal of a user and prior to transmission of the symbol to a base station the transmitter receives from the base station information about a frequency band to be used for the transmission.

In a further embodiment the base station checks incoming signals of the mobile terminal with a plurality of modulation modes and uses a modulation mode recognized as being correct for reception of the signals of the mobile terminal. For example the base station receives signals by means of a plurality of receivers, wherein a modulation mode is associated with each receiver, and the mobile terminal uses one of the modulation modes available at the transmitter end, for transmission of symbols to the base station.

In accordance with a further aspect there is provided a transmitter for carrying out the method according to the invention.

A transmitter for carrying out a method has a transmitting unit which is adapted to produce signals representing logic symbols (in this paragraph hereinafter referred to as symbols) and emitting same, wherein a logic symbol represents either a bit or a plurality of bits. In addition the transmitter has a control unit which is adapted on the basis of items of information present about currently prevailing transmission conditions between the transmitter and a receiver of the symbols to produce and deliver control signals which prescribe for the transmitting unit a receiver-specific transmission energy which corresponds to an upper limit value in respect of a error recognition rate associated with the receiver or a lower value than the limit value of the error recognition rate, wherein the control unit is additionally adapted, for the purposes of achieving the receiver-specific transmission energy and at the same time a bit rate which is as high as possible in dependence on the currently prevailing transmission conditions between the transmitter and the receiver, to produce and deliver control signals which prescribe for the transmitting unit the use of symbols with a suitably adapted symbol duration, or with a suitably adapted number per symbol of transmitted bits, or with a suitably adapted symbol duration and a suitably adapted number per symbol of transmitted bits.

Different embodiment of the transmitter according to the invention are set forth below. The advantages of the transmitter according to the invention and the embodiments thereof follow directly and clearly from the foregoing description of the method aspects of the invention and the different embodiments of the method according to the invention.

In particularly preferred embodiments by way of example of the transmitter according to the invention signals which can be emitted are stored in a memory or can be read out of a shift register structure.

Alternatively or additionally in a particularly preferred embodiment the transmitting unit of the transmitter is adapted to produce any signal to be emitted by the execution of one or more algorithms which are implemented in the form of a suitable circuit or in the form of software. The transmitting unit produces the respective signal which is currently to be emitted in dependence on control signals from the control unit. In that way it is possible to produce any signal forms, for example chirp signals or BPSK signal sequences.

Preferably the transmitting unit has a signal sequencer and an IQ modulation unit connected at the output side thereof. A signal to be emitted, after the production thereof, is passed to the signal sequencer and then to the IQ modulation unit and then converted directly into the carrier band.

Further preferred embodiments of the transmitter according to the invention have a programmable transmitter structure (software radio). The transmitter structure, in particular the operating modes of the transmitter, are preferably dynamically variable. A plurality of transmission symbols can be produced in that way.

A further embodiment of the transmitter according to the invention has a channel estimation unit in order to determine the channel properties as exactly as possible.

In accordance with a further aspect of the invention there is provided a receiver for carrying out the method according to the invention. The features of the receiver according to the invention and its preferred embodiments follow directly and clearly from the description of the method aspects and the embodiments therein.

Preferably the receiver has a programmable receiver structure (software radio). The receiver structure and in particular the operating modes of the receiver are dynamically variable in an embodiment.

In accordance with a further aspect there is provided a transmitting and receiving system for carrying out the method according to the invention. The features of the transmitter-receiver arrangement according to the invention and various embodiments are described below. The advantages thereof follow directly and clearly from the foregoing description of the method aspects and the transmitter according to the invention and the receiver according to the invention.

### BRIEF DESCRIPTION OF THE DRAWINGS

The invention is described in greater detail hereinafter by means of embodiments by way of example and with reference to the Figures:

FIG. 1 is a diagram which serves to explain the term “energy budget” of a transmitter on the basis of the relationships between the magnitudes of spectral transmission power density, transmission frequency and time,

FIG. 2 is a diagram in which the reception energy E_{receive} is plotted as a function of the distance between the transmitter and the receiver in a method in accordance with the state of the art,

FIG. 3 is a diagram in which, to describe an embodiment, the transmission power and the reception power are shown with the reception energy remaining the same as a function of time for different receivers,

FIG. 4 is a diagrammatic drawing of a wireless local loop for comparing a power management method and the energy budget management,

FIG. 5 shows a further view to compare a power management method and energy budget management,

FIG. 6 is a diagrammatic representation of a data frame in a TDMA method in accordance with the state of the art,

FIG. 7 is a diagrammatic representation of a data frame in a TDMA method with energy budget management,

FIG. 8a shows compressed symbols with different frequency spreading,

FIG. 8b shows a representation of superimposed, time-spread signals, and

FIGS. 9 through 13 shows block diagrams of different embodiments by way of example of transmitter-receiver structures.

### DETAILED DESCRIPTION

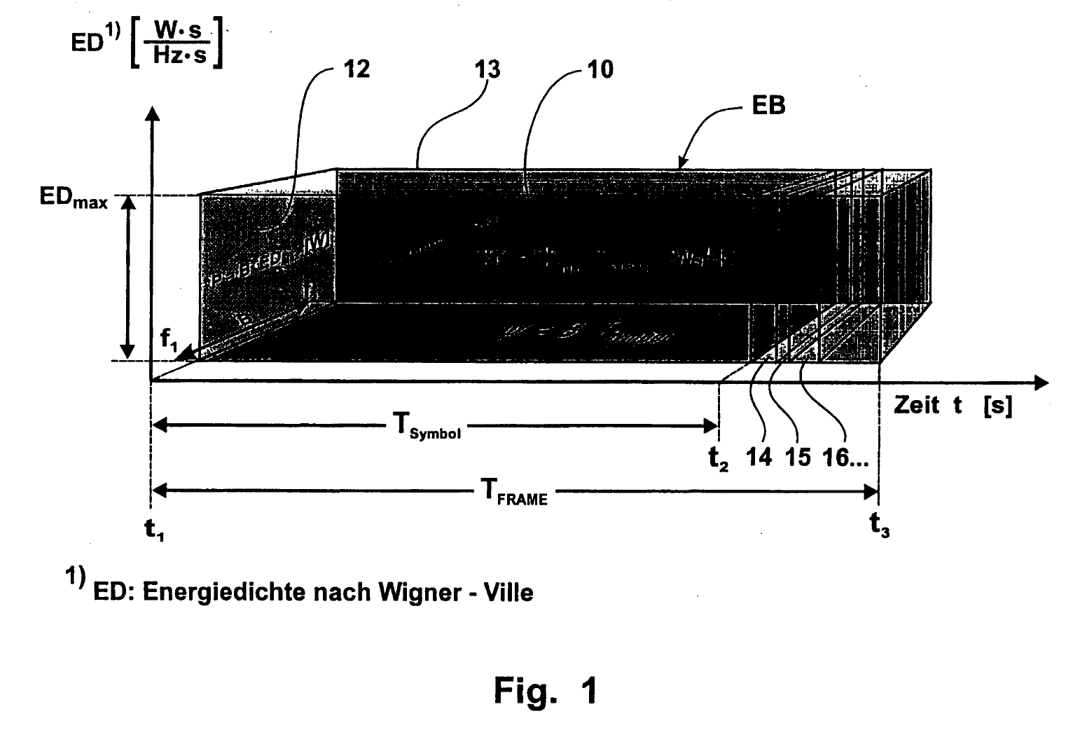

FIG. 1 shows a diagram which in a three-dimensional representation illustrates relationships between the magnitudes energy density ED, transmission frequency f and time t. The time t is plotted on the horizontal axis which is in the plane of the paper (x-axis) while energy density ED is plotted on the vertical axis in the plane of the paper (y-axis). The transmission frequency f is plotted on the axis which extends away in perpendicular relationship to the plane of the paper (z-axis).

Below the time axis the duration of a data frame is represented by the length of a double-headed arrow identified by T_{FRAME} between two moments in time t₁ and t₃. Symbols 13 through 16 are also represented, as portions of a cuboid EB along the time axis. The symbols 13 through 16 have different symbol durations T_{symbol}. For the symbol 13 the symbol duration T_{symbol} is illustrated by means of a double-headed arrow between the moments in time t₁ and t₂.

A bandwidth B which is available on a channel between two limit frequencies f₁ and f₂ is identified by the length of a double-headed arrow arranged parallel to the z-axis.

During a symbol duration T_{symbol} the spectral energy density:
ESD=ED_{max·T}_{symbol} (2)

can be transmitted at a maximum on a frequency f. Its value is provided in the representation in FIG. 1 for the symbol 13 as the area content of a rectangle 10 which extends in an (ED,t) plane determined by the frequency over the period of time T_{symbol} of the symbol 13 and the energy span from 0 through EDₘₐₓ. The three-dimensional representation therefore contains the classic definition of spectral energy density.

The power P which can be radiated by the transmitter at a moment in time corresponds to a given moment in time t in the diagram in FIG. 1 of an (ED,f) plane 12 of the cuboid EB. The three-dimensional representation therefore contains the classic definition of present power.

The illustrated energy density can be determined for example with a Wigner-Ville transformation.

The spectral energy density at a given frequency f is limited upwardly to a value ESD, for example in consideration of statutory provisions. Equally the mean or maximum transmission power is limited in consideration of statutory provisions or in consideration of the technical options of the transmitter which limits its transmission power to a maximum value. The energy density which is possible on the basis of such a limitation is symbolized by the length of a double-headed arrow arranged parallel to the y-axis.

By virtue of the frequency bandwidth B of a transmission channel between a lower limit frequency f₁ and an upper limit frequency f₂, in the view shown in FIG. 1 there is a cuboid EB whose extent along the frequency axis is equal to the bandwidth B of the transmission channel.

The cuboid EB characterizes the limited energy budget of the transmitter, which is available to the transmitter on a channel of the bandwidth B in the period of time T_{FRAME}.

In this connection the relationship between bandwidth and symbol duration is also fundamental. It is known that the maximum bandwidth is fully utilized by short symbols. Specifically, for example for rectangular spectra, the bandwidth is fully filled by si-functions. That follows from the relationship between si-functions and rectangular functions by way of the Fourier transform:

$$\begin{matrix}si ( π \cdot \frac{t}{T} ) • - • T . rect ( \frac{ω}{2 π / T} ) Fourier - transformed with \\ si ( x ) = sin ( x ) / x and rect ( x ) = \{ \begin{matrix}1 for \vert x \vert \leq 1 / 2 \\ 0 for \vert x \vert > 1 / 2\end{matrix}\end{matrix} \qquad ( 3 )$$

Accordingly in the baseband there is the following simple relationship between pulse duration and limit frequency:

$${f}_{g} = \frac{1}{2. T} \qquad ( 4 )$$

wherein the pulse duration T denotes the minimum distance between two symbols which is possible without intersymbol interference phenomena.

As a general rule a carrier frequency is additionally used for the transmission so that the transmitted bandwidth B corresponds to double the magnitude of a limit frequency f_{g} in the baseband (B=2f_{g}).

The cuboid portions 13 through 16 shown in FIG. 1 symbolize the components of the energy budget which are used for the transmission of the respective symbol by the transmitter, during the frame duration T_{FRAME}. It will be seen that the symbol duration of the second symbol 14 is less than that of the first symbol 13. In a corresponding fashion the transmission energy of the second symbol 14 is less than that of the first symbol 13.

The following findings can be derived from the model in FIG. 1:

a) the channel resources available to a network operator are for example bandwidth, maximum transmission power and time. The cuboid EB in FIG. 1 corresponds to the energy budget available to the operator of the transmitter on all frequencies which are used thereby of a channel, during a frame. That however does not signify that the frame duration T_{FRAME} is fixed. It can also be varied by the energy budget management.

b) economical operation of a transmitter requires full utilization of the available energy budget. The maximum transmission power and the available bandwidth should always be used over the entire time period of transmission operation in order to make optimum use of the available resources.

c) flexible adaptation to variable transmission conditions between a transmitter and the active receivers associated therewith is achieved by management of the energy budget available to the transmitter in a period of time. The essential physical parameter for successful information transmission from the transmitter to a respective receiver is not the transmission power but a sufficiently high amount of the bit-related reception energy. An essential feature of the methods according to the invention is therefore bit duration management with a predetermined transmission power in the form of receiver-specific adaptation of the bit-related transmission energy by way of a variation in the bit-related duration of a symbol. Those findings are discussed in greater detail hereinafter.

Regarding a) Channel Capacity and Energy Budget

An available transmission channel can be optimally used theoretically according to Shannon by the amount of data:
C=B·log₂(1+S/N)[bit/s] (5)

specified in bits per second, being transmitted in error-free fashion per unit of time. In that respect B denotes the bandwidth of the channel and S/N denotes the ratio between signal power at the receiver end and noise power. The noise power is the total of the thermal noise at the receiver end and interference phenomena which occur due to human or industrial influences (human made noise, industrial noise). The parameter C is identified as the channel capacity.

Fundamental properties for economical channel management can be read off at the above-specified Shannon formula (5).

The capacity of a transmission channel between a transmitter and a receiver essentially depends on the ratio of the received signal power S to the prevailing noise power N in the receiver, referred to for brevity as S/N. Evidently therefore channel capacity is not a fixed value which is constant for a cell or a local network but a dynamic value which can be subjected to considerable variations depending on the respective quality of the transmission channel from one receiver to another, and in the course of time.

Regarding b) Utilization of the Channel Capacity

The channel capacity according to Shannon as set forth by equation (5) is always limited by virtue of predetermined restrictions in the transmission channel. In other words: the channel capacity at a given moment in time is a limited resource and is the actual economic good which a network operator acquires by setting up a communication network, whether it is a wired communication network or a wireless communication network. The capital investment necessary for that purpose require optimum utilization of the channel capacity afforded in order to be able to operate economically therewith.

Full utilization of the available capacity of a transmission channel is possible only when the predetermined transmission power, preferably the maximum admissible transmission power, is radiated on the channel.

Regarding c) Energy Budget Management

The foregoing formula from Shannon specifies the maximum data rate which can be error-free transmitted. In practice transmission errors occur. In that connection the bit error rate (BER) is a fundamental parameter in telecommunications. Transmission errors have to be corrected by suitable measures. That is effected for example by incorporating redundancy at the transmitter end into the data stream to be transmitted. Errors can be recognized in that way.

The bit error rate crucially depends on the selected modulation. In general terms, with all modulation modes, it is possible to derive a relationship between bit error rate and the ratio of the transmitted symbol energy Eₛ in relation to the noise power density Nₒ.

It is therefore essential that, for the successful transmission of information, the transmitter affords the receiver per symbol or bit a minimum energy related to the noise power density, for recognition of the symbol. The required minimum energy is dependent on the currently prevailing noise power density and the BER which is associated with receiver and which is provided for same for example on the basis of a contractually agreed transmission quality. Furthermore the required minimum energy is dependent on the distance between the transmitter and the receiver.

In order clearly to illustrate the consequences drawn in accordance with the invention from the model shown in FIG. 1, three cases by way of example are described hereinafter.

a) Low Attenuation

Firstly a favorable case will be considered, in which attenuation between the transmitter and receiver is relatively low. In that case a very great channel capacity is available to the corresponding user. The shortest possible symbols which can be implemented in relation to the bandwidth present are always sent, so that the transmission energy per symbol assumes the minimum value, with at the same time the maximum transmission power. Optionally, higher-stage modulation corresponding to the reception quality is additionally applied so that the energy available at the receiver is put to maximum use.

For that case the optimum symbol energy is determined for example by BER being considered for various modulation modes and by that modulation mode with which the required transmission quality is just still guaranteed being selected. At the same time that provides for selection of that higher-stage modulation with which the data can be transmitted as quickly as possible so that the channel capacity involved is put to optimum use. In that case the symbol duration is no longer altered as it is already reduced to the minimum value which corresponds to the reciprocal of the bandwidth.

The provision of that high channel capacity means that the amount of data required can be transmitted very quickly so that subsequently the physical channel is available to one or more users by virtue of employing suitable multiplexing methods. For example a TDMA method is advantageous in that connection so that the management complication and expenditure involved is kept within limits.

b) High Attenuation

Another case which is referred to here as the worst case scenario involves a user whose physical transmission channel has a very high degree of attenuation, either due to a great distance or due to fading holes which occur due to multipath propagation phenomena. In that case the channel capacity available for the receiver is very small and the transmitted symbol energy must be very great, that is to say very long symbols are emitted.

For that situation the optimum symbol energy is determined by consideration being given only to the simplest available modulation. For that modulation, the minimum energy to be received, with which for example the required BER is maintained, is fixedly preset so that the symbol duration must be altered dynamically in the transmitter in order always to produce the subscriber-related symbol energy at the receiver.

In this situation the symbols are markedly longer than the shortest symbol duration which is predetermined by the bandwidth. Optimum use of the channel capacity is therefore to be considered once again in more specific terms as there the bandwidth of the channel is also involved, besides the S/N [W/W].

If the bandwidth of the symbol used is less than the predetermined bandwidth, the maximum channel capacity cannot be used and further additional measures must be taken. Such measures are now discussed:

Long symbols do not necessarily signify small bandwidth, that is shown by chirp signals, as is shown in DE 199 37 706. In that case the long symbols can be replaced by chirp signals which are of the same duration. In that case the product of time duration and transmission power is identical for both pulse forms, that is to say the energy is the same. The chirp signals however cause frequency modulation (which in the simplest situation extends linearly but in general can assume any, monotonically rising function configurations) which can extend over the entire predetermined bandwidth. In that way the signals are spread in respect of frequency. That situation is considered in greater detail hereinafter.

It is also possible for the symbols to be spread in respect of frequency by being additionally modulated with a pseudo-noise sequence. It will be appreciated that that modulation must be known to the receiver and must also be dynamically adapted to the selected symbol duration.

A specific variant of energy budget management can provide for predetermining a long pseudo-noise sequence, for example a m-sequence, the chip duration of which reflects the given bandwidth. With a maximum bandwidth the various symbol durations can then be implemented in discrete steps (integral multiples of the chips), by always using a portion of the predetermined sequence.

The energy contained in the spread symbol can be put to optimum use only when suitable correlation receivers are used, for example if there is a suitable matched filter in the receiver which must be dynamically adapted.

Alternatively, with the long symbols, it is also possible to superimpose an FDMA so that the bandwidth involved is divided and the user involved is allocated only a small part of the bandwidth, which corresponds to the length of respective data symbol. Two or more FDMA channels could then be operated in parallel.

A specific embodiment can provide for the implementation of an uplink and a downlink channel in the form of frequency division duplex (FDD) which are operated in parallel in respect of time.

In that respect the dynamics of the transmitter which have already been discussed hereinbefore are of crucial significance. In the specified FDMA, it would now be possible for example for two channels to be operated in parallel, in which case one corresponds to the first case with higher received energy and the second corresponds to the worst case scenario considered. The optimum symbols therefore differ considerably in the two channels.

c) Disturbed Channels

As a concluding example, consideration is given to channels which suffer from very severe multipath propagation and/or additional interference signals. In that case the quality of the received signal is crucially dependent on the selected spreading of the signal. Energy budget management directly involves that parameter as the maximum bandwidth can always be used so that spreading and at the same time symbol energy increase with an increasing time duration for the pulses.

It is not crucial in terms of optimum use of the channel resource that the worst case is also maintained, but that in the best case the maximum possible data rate is transmitted and thus the properties of the channel can be optimally used. It is accordingly possible for the channel capacity of the network to be markedly increased, as will be discussed in greater detail hereinafter.

The foregoing examples show as follows: energy budget management preferably entails multi-dimensional optimization of all physical parameters which define the channel resources, the time axis, the frequency axis and the maximum transmission power.

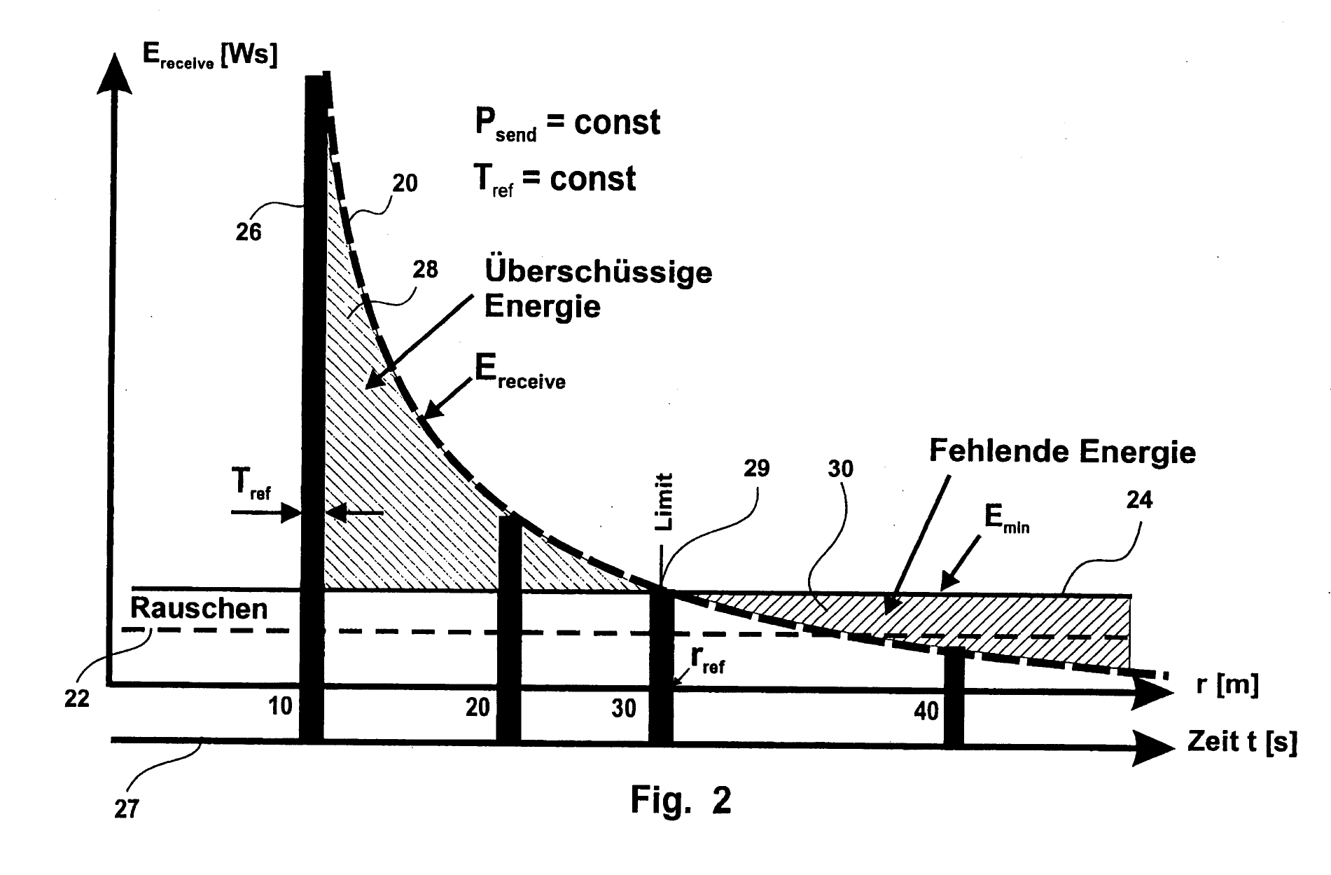

A typical telemetric communications use and the implementation thereof in accordance with the state of the art is described in rather more detail hereinafter with reference to FIG. 2 in order to illustrate the physical boundary conditions in the transmission channel and to discuss the consequences according to the invention.

In wireless transmission methods, the situation arises where the received energy per symbol for free-space propagation decreases approximately quadratically with distance. As a simplifying assumption it is presupposed in this example that only one modulation mode is used and no higher-stage modulation processes are employed. It is further assumed that the symbols are always radiated with the same duration T_{ref} and the same transmission power P_{send} for each subscriber.

FIG. 2 now shows a diagram in which the reception energy E_{receive} is plotted as a function of the distance r between a transmitter and receiver of a wireless transmission network. The distance r is plotted on the abscissa and the reception energy E_{receive} is plotted on the ordinate. The functional dependency between reception energy and distance r between transmitter and receiver is as follows:

$${E}_{receive} \sim \frac{1}{{r}^{2}} \qquad ( 6 )$$

That relationship is reproduced in the FIG. 2 diagram by a curve 20.

A noise power density is shown parallel to the abscissa in the form of a broken line 22. Also shown parallel to the abscissa is a solid line 24 which identifies the magnitude of the minimum symbol energy Eₘᵢₙ which is required for achieving a receiver-specific bit error rate BER and which is predetermined by the modulation mode used. The constant symbol duration T_{ref} is shown as the width of a bar 26 in parallel relationship with a second horizontal axis 27, a time axis.

In this simple model system in accordance with the state of the art there is precisely one distance r_{ref} between transmitter and receiver, at which the reception energy E_{rec} precisely corresponds to the minimum value Eₘᵢₙ required for recognition. A bar 29 shows the minimum reception energy Eₘᵢₙ which, with the distance r_{ref} between transmitter and receiver, within the cell, still leads to correct reception.

If now the network is dimensioned on the basis of that worst case scenario, that is to say in relation to the transmission power and the link budget, a maximum symbol duration is determined, which when multiplied by the maximum transmission power gives the maximum transmission energy, then with all nearer users the received energy and thus the symbol duration are too great. Receivers which are arranged at a shorter distance in relation to the transmitter than r_{ref} receive more energy than is required. Receivers which are at a greater distance in relation to the transmitter than r_{ref} receive a level of energy which is not sufficient for recognition of symbols with the predetermined BER.

From the point of view of the transmitter, for r<r_{ref}, the reception energy region 28 between the straight line 24 (Eₘᵢₙ) and the distance-dependent curve 20 is excess wasted energy. For, that energy is not required at the receiver for recognition with the predetermined BER. On the other hand, in the distance range r>r_{ref}, the reception energy region 30 between the straight line Eₘᵢₙ and the distance-dependent curve 20 is a lack of energy for recognition at the receiver end with the predetermined BER, with the given noise power density.

Now, for the closer receivers, the transmission power could be adjusted down by a power management method in accordance with the state of the art. However that means that the channel resource transmission power is not fully used.

In an embodiment of energy budget management (EBM) the symbol duration at maximum transmission power is varied and thus the energy of the transmitted symbol is adapted to the requirements of the channel without reducing the transmission power. The energy budget is thus divided up insofar as respective subscriber-specific symbol durations and thus energy packets are sent to each subscriber at full transmission power. In that way, for each user, the optimum symbol duration is calculated in dependence on the received power in such a way that only that symbol energy is applied in the transmitter, which is required for reception at an error recognition rate predetermined for the receiver. That is characterized in FIG. 2 by Eₘᵢₙ. The transmitter uses the transmission energy saved in that way in accordance with energy budget management for example in the context of a TDMA method for adaptation of the symbol energy for those receivers which have at the current time worse reception conditions, or for the operation of further transmissions to receivers in the close area. In that way the range of the transmitter can be increased by management of the energy budget.

That therefore makes better use at one end of resources which are additionally available at the other end in order to serve subscribers who, in the case of methods in accordance with the state of the art, would be just outside the cell and could no longer be reached by the base station.

The variation in symbol duration is limited downwardly. The shortest symbol duration corresponds to the maximum bandwidth which as an additional parameter restricts the transmission channel.

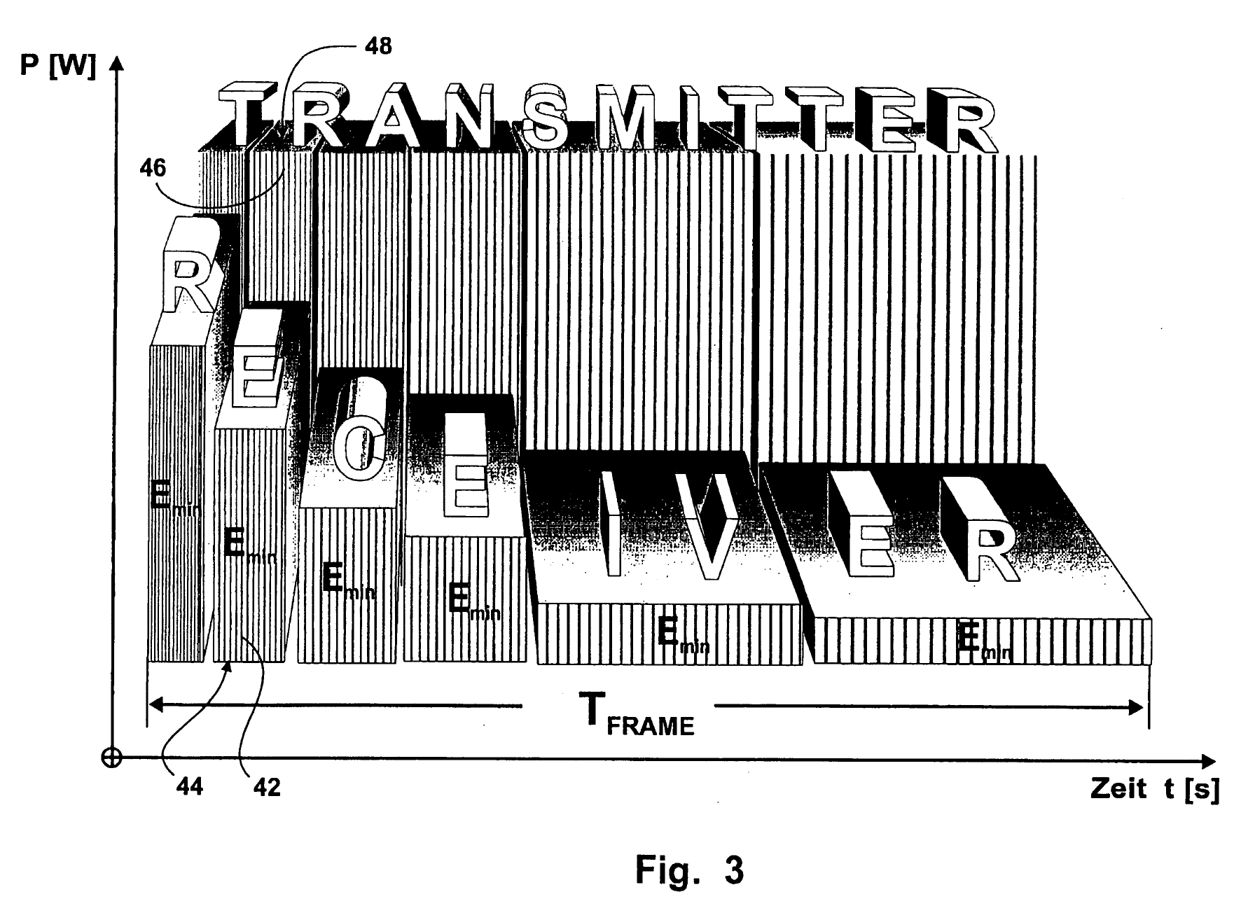

FIG. 3 shows the consequences of the method according to the invention in a bar chart plotting the transmission and reception powers in relation to a time axis for various examples. The respective reception energy is illustrated in the foreground, for example by the front face 42, which faces towards the viewing person, of a cuboid 44, with a reception power which is determined by its height along the y-axis and a symbol duration which is determined by its width along the x-axis. The transmission energy corresponding to the respective bar of the reception power is illustrated in the background, for example in the form of the front face 46 of a hatched bar 48. The mutually associated transmission power and reception power bars naturally involve the same symbol duration, illustrated as an equal extent along the time axis. The bars however differ in terms of heightwise extent: the reception power is always less than the associated transmission power.

The different bars shown in juxtaposed relationship along the time axis correspond for example to different receivers with a distance, which increases in the direction of the time axis, from the transmitter, or receivers with a different allocated data rate. An attenuation effect which is common to all illustrated examples and which is solely distance-dependent is assumed to apply. The same BER is to be made available to all receivers, as a further boundary condition. To permit that the reception energy must always reach the value Eₘᵢₙ. All cuboids which are arranged in the foreground and which represent the reception power as a function of time accordingly have the same area content of the front faces in FIG. 3. For this, receivers which receive the symbol with a lower level of power, which therefore are at a greater distance from the transmitter, have communicated thereto the symbols with a correspondingly longer symbol duration.

The third co-ordinate, the depth of the bars, represents in this case the bandwidth used, which is predetermined for the channel as an additional parameter. That is shown as being constant here as, even with a variable time duration in respect of the symbols, a suitable spreading effect can always be found so that this provides that the full bandwidth is used.

In a method according to the invention, as shown in FIG. 3, the transmitted data symbols are dynamically adapted in respect of energy insofar as their time duration is adapted. In that respect the transmitter is operated here in such a way that it always radiates on a respective channel the admissible maximum of the transmission power, as is shown by the transmission power which is the same for all examples in FIG. 3. The symbols are dynamically adapted in their bit-related duration in order to afford a reception quality which remains the same, that is to say the same reception energy Eₘᵢₙ, to a receiver in question, in dependence on the currently prevailing condition of the transmission channel.

In that respect, in accordance with the invention, with the same symbol duration, it is additionally possible to select a higher or a lower modulation stage so that a higher or a lower number of bits is transmitted with a symbol. The minimum energy shown in dependent in that respect on the respective modulation mode.

An embodiment for the above-described energy budget management will now be described in greater detail with further reference to FIGS. 1 through 3, with the central aspects being set out once again for that purpose.

In wireless transmission methods, the situation arises where the received energy, per symbol, for free-space propagation, decreases approximately quadratically with distance. The minimum energy which is necessary for reliable reception of the symbols in contrast depends only on the modulation selected and is therefore constant. Accordingly, with a predetermined maximum transmission power, the maximum cell radius is determined by the distance r_{ref} in FIG. 2.

If the network is dimensioned on the basis of that worst case scenario, that is to say a maximum symbol duration which multiplied by the maximum transmission power affords the maximum transmission energy is determined in relation to the transmission power and the link budget, then the received energy and therewith the symbol duration are too great in the case of all closer users.

In that case, when using power management, the transmission power could be adjusted down so that the transmitter assumes a condition of being adapted to the situation. This means however that the channel resource transmission power is not fully used. In that case energy budget management can advantageously be applied by the symbol duration being reduced. That implements a markedly higher data rate and the channel occupation duration is reduced. That makes it possible for example to carry out a TDMA method.

The optimum symbol duration is calculated for each user. In a preferred embodiment the symbol duration T_{symbol} is determined at the transmitter end in accordance with formula (1).

That dynamic control of symbol duration in dependence on the reception quality is in principle possible in any system.

What is crucial however is the question relating to optimum use of bandwidth as in general the bandwidth of the symbol is simultaneously altered with the dynamic symbol duration. On the one hand the respective bandwidth can be regulated dynamically by implementing an FDMA procedure in which the bandwidth is dynamically divided up according to the requirements involved. That implementation of such a method in hardware terms is very complicated and expensive. In contrast such dynamic separation can be implemented in a software radio.

Furthermore it is possible, in relation to the bandwidth, to define the shortest symbol (chip) and to form the data symbols by arranging a plurality of those chips in succession insofar as certain sequences represent the symbols. Energy budget management is then combined with frequency spreading. That case involves quantization of the dynamic variation in the symbol duration by the chips used.

In particular however chirp signals are suitable for that use, in respect of which a distinction can be drawn between frequency spreading and time spreading, see DE 199 37 706. In that case frequency spreading is effected by a procedure whereby the pulses which are shortest in relation to the bandwidth are produced and then those pulses are expanded in time spreading to any duration. That expansion of the pulses can then be effected dynamically according to the energy required.

High data rates are achieved with that method insofar as the individual chirp signals are in mutually superposed relationship in time. The maximum transmission power which a user can use is therefore divided up so that each chirp signal gets only a fraction, depending on the respective degree of the superimposition effects.

That is possible as the symbols are compressed in the receiver to short pulses, the maximum of which is in the zero positions of the other pulses. Those si-shaped pulses naturally reflect the bandwidth used.

In this case also there can be a quantized increase in symbol energy insofar as fewer and fewer symbols are mutually superposed and thus the power of the individual symbols is increased stepwise until there is no longer any overlapping of the symbols. The consequence of this is that the compressed pulses are at a progressively increasing distance relative to each other and more zero positions remain empty.

Dynamic allocation of the symbol duration is restricted downwardly by the bandwidth. That predetermines the shortest pulse which can be used in modulation. There is however no limitation on the other side, that is to say the symbols can also be extremely long.

That will be described with reference once again to FIG. 2. The cell sizes which are usual nowadays are described by the point r_{ref} at which the signals can just still be received. No further reception is possible in the conventional systems, beyond that point. Therefore, a user who is only slightly outside the cell has to set up a fresh cell. That can give rise to very high costs specifically in the case of wireless local loop (WLL) arrangements.

The energy budget management by means of energy modulation described herein makes it possible for even that user still to be serviced from the same base station by the symbols becoming even longer and thus bearing more energy. That therefore provides for dynamic expansion of the cell in individual directions at which users are to be found. That is a particularity which is not encountered in other channel management methods.

The production of long symbols in a transmitter often does not cause any difficulties. In contrast in the receiver major problems can be involved in receiving long symbols with a small bandwidth, particularly if FDMA is used and the frequency must be accurately hit. In general it is more appropriate here to spread the symbols and to use a correlation receiver. That applies equally for CDMA sequences and also for chirp signals.

Those receiver types also basically correspond to the conventional matched filter which is used for optimum transmission.

Dynamic energy modulation and thus symbol duration variation mean that this filter also has to be dynamically adjusted. That is also possible in an implementation in the form of software radio.

The distinction between base stations and subscribers is also essential for application of energy modulation. Bandwidth and power are generally restricted for the telecommunications channel. It is therefore possible for the subscriber to emit the data symbols at full power and, with corresponding frequency modulation, to produce the optimum symbol length. The frequency band necessary for that purpose must be previously enabled by the base station so that the users do not interfere with each other.

In the converse case that is not so easily possible as splitting up the channel into individual frequency bands at the same time also means dividing up the maximum transmission power as the total of all transmission powers over frequency is not to exceed the maximum admissible power. In consideration of the known clear links between transmission power, symbol duration and bandwidth it is possible to dynamically calculate the optimum energy modulation in each network and thus to embody a maximum channel capacity in a network.

The operation of determining the setting values is described hereinafter. As discussed in greater detail hereinbefore, energy budget management is based on transmission energy being adapted in receiver-specific fashion, for example in relation to a base station or an access point. Accordingly, for example with good transmission conditions, higher-stage modulation is effected while with poor transmission conditions an increase in symbol duration is produced.

So that this method can be controlled automatically the necessary regulating values must be ascertained and efficient modulation must be agreed between transmitter and receiver. There are in principle various ways of doing that. All power management methods which are usual nowadays can be adopted for energy budget management as therein the power at the receiver is ascertained and thus the received energy is known for the corresponding symbol and extrapolation is possible therefrom for all other available symbols. Two principles are set forth here by way of example.

The received power can be measured directly by simple RSSI measurement (radio signal strength indicator) in the receiver. In that way the reception quality is known and it is possible to tune optimum modulation and/or symbol duration and/or spreading between base station and subscriber. In that respect in general the values of base station and subscriber are different as different interference phenomena can occur at the various locations.

Secondly the quality of transmission can also be determined by measurement of the errors within a frame, if for example an error recognition code is used. Modulation and/or symbol duration and/or spreading can then be altered stepwise until the optimum transmission efficiency is reached.

Regulation can be continuously re-adjusted in an existing connection or an ongoing data traffic, without the transmission breaking down.

It is in contrast more difficult to make a connection in a cellular network. Here a subscriber sends a request to the base station in the access channel. That may possibly not be received by the base station as the modulation employed is not known.

Here too there are various solutions. Firstly, it is always possible to use the physically most robust connection which must always function in a correctly dimensioned network. This however involves squandering resources.

A further possible option is to set up a plurality of receivers in the base station so that various modulation modes are allowed in the access channel and the respective subscriber starts the transmission with the modulation last used. In parallel reception there is then always one which is tuned to the transmitted modulation.

In general repeated inquiry of the access channel is also possible, in which case the conceivable modulation modes and/or symbol durations and/or spreads are systematically checked. Efficient algorithms can be envisaged here, as are nowadays already used in systems which employ various carrier frequencies for data communication.

The same problems arise in the case of CDMA systems in which a specific spread code must be dynamically allocated to each user before the actual connection (traffic channel) is ready.

Likewise it is possible in energy budget management to determine the optimum symbols which are to be used for the transmission before they are employed in the actual traffic channel.

In that respect it is also possible for the transmitted symbols to differ from the received symbols as the losses and interference in the channel between uplink and downlink can be different.

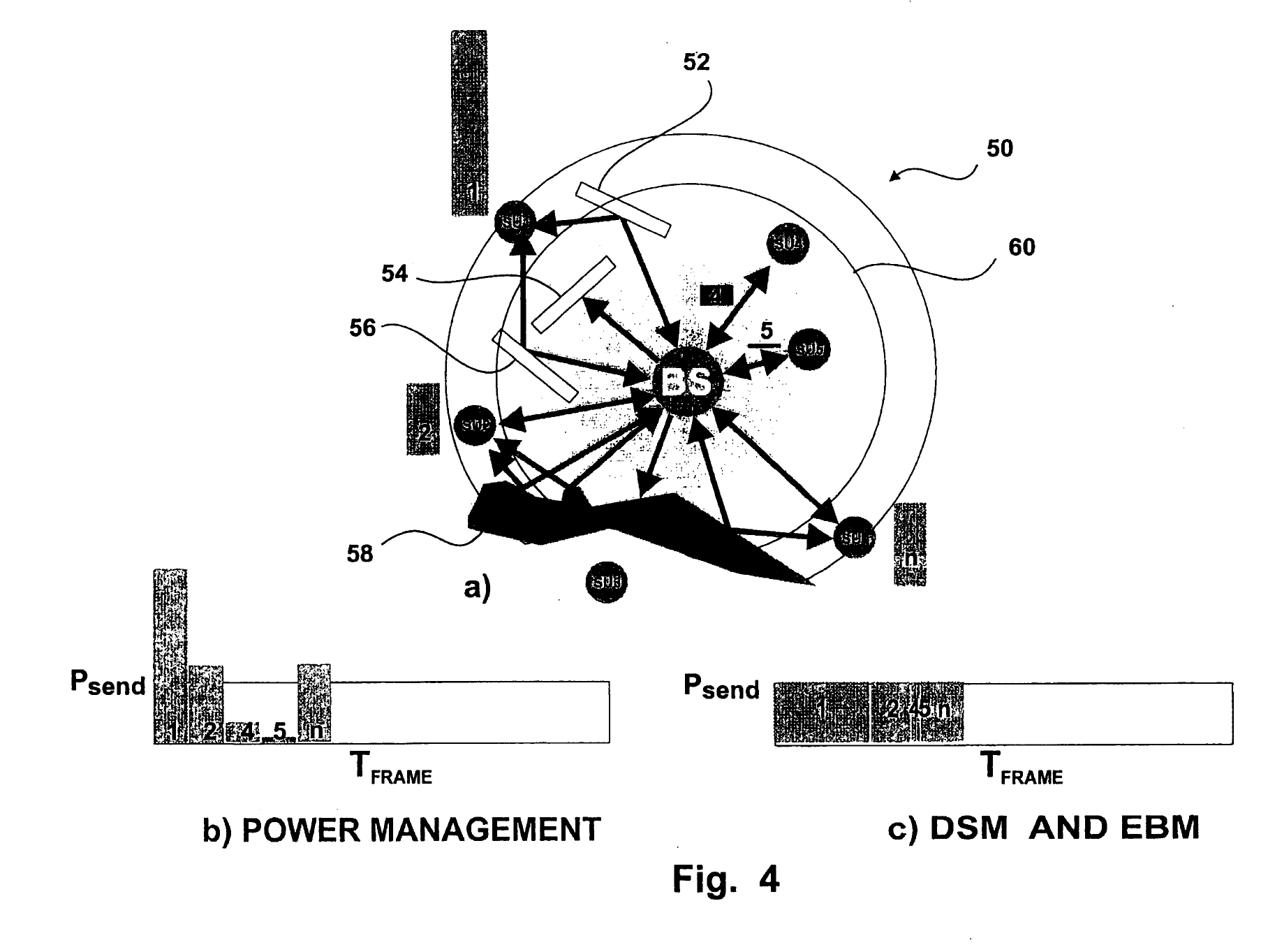

FIG. 4a) is a diagrammatic view showing a wireless local loop network 50 with a base station BS. Subscriber stations are identified as SU1 through SU5 and Sun (English SU=Subscriber Unit). In addition propagation obstacles for radiation of the transmitter are identified by references 52 through 58. The obstacles 52 through 56 are for example high buildings, while the obstacle 58 is a mountain range such as for example the Alps.

In comparison with the preceding examples the transmission energy here is no longer dependent exclusively on distance but on further factors. In the general situation the required transmission energy is determined by the following important parameters. Further, less important parameters which however are known to the man skilled in the art are not set out in the following list:
modulation mode
distance between transmitter and receiver
interference and noise
required BER (for example for special security uses)
multipath propagation (line-of-sight, non-line-of-sight)
antenna characteristic

The cell size is predetermined in accordance with known methods by the maximum (admissible) transmission power of the base station (BS). It is symbolically indicated in FIG. 4 by a circular line 60. Within that cell, the individual subscribers are sometimes closer to the base station (thus SU5) and sometimes further away from the base station BS (thus SU4), while in addition signal distortion occurs due to multipath propagation as well as shadowing of the signal due to large buildings 52 through 58. The mountain range 58 represents an insuperable obstacle so that the subscriber SU3 which is out of sight of the base station BS beyond the mountain range cannot be reached.

By virtue of the multiplicity of transmission channels present, individual subscribers can be reached well, others poorly and some not at all. FIG. 4b) in the form of a bar chart shows the transmission powers which are required with correspondingly previously known methods with a constant symbol duration and which are required for transmission to the respective SU. The numbering of the bars corresponds to that of the subscribers. By way of example bar 1 symbolically represents the transmission power associated with the subscriber SU1. The two subscribers SU1 and SU2 are outside the range of the base station BS and can only reached with levels of power which are higher than the admissible peak power P_{send}.

FIG. 4c) in contrast shows for comparison purposes the solution achieved with bit duration management. Reception with the same reception energy at the subscribers involves using a respective suitably adapted transmission energy which is set by adaptation of the symbol duration with the maximum transmission power P_{send} in each case. The channel capacity present is distinguished within the network for each subscriber, on the basis of the different channel properties. That fundamental physical property constitutes an essential difference in relation to network organization methods which are usual nowadays and which seek to allocate the same channel capacity (or data rate) to all subscribers of a cell.

The task of telecommunications could now be stated in fresh terms insofar as the optimum data rate at the respectively admissible error rate can be dynamically offered to each subscriber within a network. The symbol energy necessary for that purpose is thus the determining regulating value of the network. It follows from that approach that the transmitted symbols may not be fixed, they must be dynamically altered at the transmitter, so that, for the selected modulation, in dependence on the transmission channel, the subscriber in question always receives the required reception quality, described for example by an error recognition rate or specifically a bit error rate.

The physical principles involved however permit that in a dynamic channel only when the transmitted data symbols are dynamically adapted in respect of energy, that is to say optimum energy modulation or optimum bit duration management is effected, or in regard to a network organization: energy budget management.

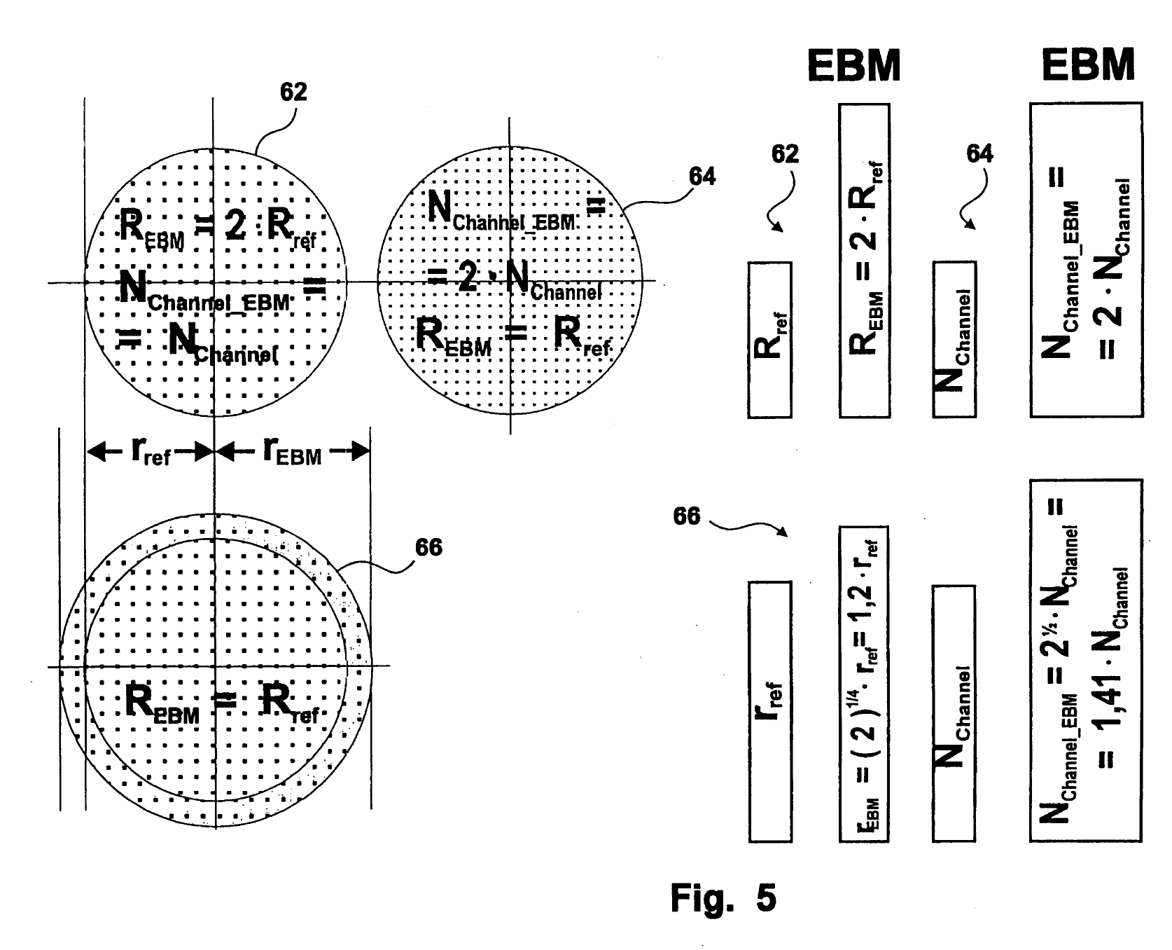

Reference will now be made to FIG. 5 to consider a general embodiment which is typical of wireless connections. A number N_{channel} of subscribers is served simultaneously from a base station, wherein one of the typical multiple access methods can be employed. The following calculations are based on a predetermined cell which is so dimensioned that the most remote user at a distance r_{ref} [m] from the transmitter, with a predetermined symbol duration T_{ref} [s] and the maximum transmission power P_{send} [W], still just receives the energy Eₘᵢₙ [Ws] which is necessary for reliable reception of the data.

It is further assumed that, in the general case, the data are transmitted with a spread. That situation therefore means that the bandwidth B [Hz] used is greater than the reciprocal of the symbol duration T_{ref} [s].

It is additionally assumed that the selected modulation mode is the same for all subscribers in the reference cell, antennae with an isotropic directional characteristic are used and propagation of the electromagnetic waves takes place in free space. All those assumptions are in no way necessary prerequisites for energy budget management. They only serve to be able to implement the calculations described herein, with simple formulae.

The reference cell being considered is served from a base station which provides a fixedly predetermined number of channels, for example in a TDMA or CSMA multiple access method. Each of those channels has a data rate R_{ref} [bits/s] which is intended to precisely correspond to the data rate required by the subscriber.

Insofar as reference is made in the description hereinafter to formulae which are not stated herein, they are to be found at the respectively specified number in Appendix 2.

The limiting physical values in the cell under consideration are the bandwidth and the maximum transmission power. It is now of fundamental significance that, for the assumed free-space propagation, the received power for each subscriber in the cell depends quadratically on the distance thereof relative to the base station.

The received power is the decisive setting value in this example, it is uniquely determined by the position of the respective user. For reception of a transmitted item of information however it is not the power that is decisive but the reception energy per bit E_{receive} which is calculated from the product of received power and symbol duration. In an optimum system therefore that value should be kept constant so that the required error rate is observed.

$${E}_{receive} = {P}_{receive} \cdot {T}_{symbol} , {P}_{receive} ( r ) \sim \frac{1}{{r}^{2}} ⇒ {T}_{symbol} \sim {r}^{2} \qquad ( 7 )$$

Let the reference system in question be a rigid system, with a fixed symbol duration T_{ref} [s], the dimensioning of which is designed to ensure the reception of the information at a maximum distance r_{ref} [m], whereby the minimum energy per symbol Eₘᵢₙ which is necessary for reception is predetermined. In that respect it is firstly assumed that in the reference system each symbol only contains one bit as information content.
Eₘᵢₙ=P_{receive}(r_{ref})·T_{ref} (8)

In many transmission methods which are usual nowadays the energy of the received symbols is kept constant by the transmitted power being reduced. In that way the channel resource available is thoughtlessly squandered. It is now to be shown here how easily the resources can be used by applying energy budget management.

The following calculations are based on a comparison of the systems, that is to say the relationships of the rigid reference system to the flexible system with energy budget management are decisive here.

Now, reliable reception of the messages with the selected modulation mode requires the energy Eₘᵢₙ [Ws] which is related by way of the channel losses to the transmitted energy.

In a first approximation that decreases quadratically with the distance r [m], but it is always limited upwardly (that is to say at small distance), for physical reasons. Formulated in general terms, the following applies for the radiation of power, under the stated conditions:

$${P}_{receive} ( r ) = \frac{{P}_{send}}{1 + ( \frac{4 \cdot π \cdot r}{λ} ) 2} \qquad ( 9 )$$

For the reference cell, that value can be easily related to the minimum energy Eₘᵢₙ [Ws], by being multiplied by the symbol duration (19). As now the duration of the transmitted symbol does not change on the air interface, the received energy per symbol can generally be viewed as a function of the transmitted energy (20).

In classical methods the base station of the reference cell now sends the signals to all subscribers with the same energy, whereby, as already explained at a number of points above, available resources are in part squandered insofar as users close to the base station are sent too much power or energy.

A plurality of users are served in “quasi parallel” relationship on the basis of the multiple access method. The number of active users in the reference cell corresponds in that respect to the number of channels N_{channel} of the access method.

The energy radiated per symbol, E_{send} [Ws], is defined as the product of maximum transmission power P_{send} [W] and symbol duration T_{ref} [s] of the reference system.

In total, in consideration of statutory provisions, the base station is permitted to radiate the energy:
E_{BS}_{_{—}}_{classical}=N_{channel}·E_{send} (10)

That energy budget is accordingly available for the cell. It is precisely at that point that energy budget management comes in. Each subscriber is only sent the transmission energy which is necessary for the subscriber to receive the signals with an energy Eₘᵢₙ [Ws].

For general derivation, the number of active users in the area being considered when using energy budget management is decisive, which can generally be described by way of user density in relation to area. Hereinafter that density is assumed to be constant (21) and is standardized in relation to the reference cell being considered. As that density is constant, the value does not alter in relation to area so that in the formulae r and φ are only formally used as variables which describe the position.

Application of energy budget management means that the resources are now optimally used insofar as each user receives the minimum energy per symbol, irrespective of his position. As the received energy is constant accordingly the transmitted energy must be altered by the energy budget management system in dependence on distance (22).

The energy radiated overall by the base station as a statistical mean is now an integral over the area-related density of the active users (23), multiplied in each case by the respective transmitted energy.

Integration over a circular area A of a radius r_{cell} [m] affords the simple formulation (24) which hereinafter is to be compared to the value already set forth in respect of the classical cell.

For that purpose consideration is firstly given to the situation where both cells are to be of the same size, that is to say r_{cell}=r_{ref}, that situation is identified by 64 in FIG. 5, and the energy radiated by the base station is to be the same for both cases.

Under those conditions, equating (10) and (24), having regard to the formula (19) for the minimum energy, there is a direct relationship between the number of active channels in both cases.

$${N}_{channel} = \frac{1}{2} \frac{2 + {( \frac{4 \cdot π \cdot {r}_{ref}}{λ} )}^{2}}{1 + {( \frac{4 \cdot π \cdot {r}_{ref}}{λ} )}^{2}} \cdot {N}_{channel\_EBM} \qquad ( 11 )$$

For all cases which are relevant in practice, that formula can further be made substantially simpler by the approximation (25). That gives the simple relationship that, by virtue of application of energy budget management, the number of channels N_{channel}_{_{—}}_{EBM} is doubled in comparison with the conventional number N_{channel} with the same cell size and the same data rate per channel (R_{EBM}=R_{ref}).
N_{channel}_{_{—}}_{EBM}=2·N_{channel} (12)

That is shown in FIG. 5 in relation to the cell 64.

Alternatively it is also possible with the same number of channels N_{channel}_{_{—}}_{EBM}=N_{channel} for the data rate per subscriber to be doubled, R_{EBM}=2 R_{ref}. Accordingly the introduction of energy budget management leads to a 100% increase in the efficiency of the predetermined cell. That is illustrated in FIG. 5 by reference to a cell 62.

As a further numerical example, reference will now be made to a cell 66 to consider the case where the density in relation to area of the active users is to be the same for both cases (26).

On the basis of the result which has already been deduced it is therefore immediately clear that less energy is emitted by the base station for the cell being considered, when using EBM. That energy difference can be used to expand the cell to r_{EBM}>r_{ref}, in (27) for that purpose r_{cell} is replaced by r_{EBM}, that is illustrated in FIG. 5 by reference to a cell 66. Resolution of the formula (27) leads to a complicated formulation which as a quotient contains only the ratio of the expanded cell to the reference cell (28), which applies for maximum expansion of the cell when using energy budget management with the same service quality for all subscribers. That formula can be again substantially simplified by having regard to the relationship (25). That gives the following:

$${r}_{EBM} / {r}_{ref} = \sqrt[4]{2} \approx 1.2 \qquad ( 13 )$$

The cell 66 is thus expanded in the radius r_{EBM} by 20% with the same service quality (data rate) in respect of all active subscribers, R_{EBM}=R_{ref}. That initially appears to be little, but in that way the number of all channels is increased from N_{channel} to

$$\begin{matrix}{N}_{channel\_EBM} = {N}_{channel} \cdot {( \frac{{r}_{EBM}}{{r}_{ref}} )}^{2} \\ = {N}_{channel} \cdot \sqrt{2} \approx 1.41 \cdot {N}_{channel}\end{matrix} \qquad ( 14 )$$

The number of channels N_{channel}_{_{—}}_{EBM} in the cell 66 can thus be increased by 41%. That advantage is graphically shown in FIG. 5.

The foregoing derivation is now to be considered in greater detail once again, in regard to technical implementation of the EBM. Evidently a subscriber who is in the proximity of the base station generally has available a channel which involves lower channel losses in relation to the subscriber who is further away. The foregoing derivation now shows that accordingly less energy has to be radiated by the base station for reliable reception of a selected symbol.

The question is now how that can be technically implemented. In that respect there are in principle two ways, variation in the symbol duration and variation in modulation.

The following derivation shows that both methods are equivalent but are subject to different restrictions so that finally it can be emphasized that the described energy budget management can in principle be optimally implemented by a dynamic variation in symbol duration and/or by higher-stage modulation.

A preferred variant involves the proposal of a combination of both methods, in which an elegant variation in symbol duration is effected until that cannot be pursued due to the restricted bandwidth, and then higher-stage modulation is applied.

At any event the above-derived formulation (24) represents the limit of the improvements which can be achieved in respect of energy budget management.

Firstly the EBM permits dynamic adaptation of the symbol duration. The transmitted energy per symbol is the product of the transmitted power P_{send} [Ws] multiplied by the respective symbol duration T_{symbol} [s]. It has already been sufficiently explained that a variation in the transmission power to a value less than the maximum allowed value signifies squandering of channel resources. That value is therefore constant.

So that the transmitted energies differ for the individual subscribers the symbol duration can be varied. Accordingly the following applies to the above-discussed case:

$$\begin{matrix}{E}_{send\_EBM} ( r ) = [ 1 + {( \frac{4 \cdot π \cdot r}{λ} )}^{2} ] \cdot {E}_{min} ⇔ {T}_{symbol\_EBM} ( r ) \\ = \frac{1 + {( \frac{4 \cdot π \cdot r}{λ} )}^{2}}{1 + {( \frac{4 \cdot π \cdot {r}_{ref}}{λ} )}^{2}} \cdot {T}_{ref}\end{matrix} \qquad ( 15 )$$

Therein Eₘᵢₙ [Ws] denote the energy which is at least required at the receiver to reliably detect the symbols and T_{ref} [s] is the symbol duration in the previously considered reference cell with classical cell organization.

The dynamic change in symbol duration is evidently a very elegant way of dynamically varying the symbol energy in the transmitter.

In general terms the bandwidth which is at least required for the transmission of a symbol is equal to the reciprocal of the symbol duration. That first approach can therefore mean that the required bandwidth is not available. Accordingly this approach can easily encounter limits which prevent optimum use of the energy budget management system.

Alternatively or in addition it is possible to effect a dynamic change in the higher-stage modulation. This second embodiment is rather more complicated and therefore has to be described in greater detail. The formulations used hitherto involve the value Eₘᵢₙ which for the general case identifies the energy which must arrive with a selected modulation in the receiver so that the receiver recognizes the information of a bit with an adequate degree of certainty. In the general case however a symbol can contain a plurality of bits.

The relationship between symbol energy and bit energy or information content of the symbol arises out of the modulation adopted. If the situation is such that the symbols have an excessive energy at the receiver, that energy could alternatively be used to alter the modulation mode and to use symbols which carry more information and therefore require more energy.

As a simple example consideration will be given here to the situation where the reference cell involves the use of BPSK modulation in which each symbol corresponds to precisely one bit. The required reception energy is identified by E_{b}_{_{—}}ₘᵢₙ, wherein the index b is intended to refer to a bit.

In the transition from BSPK to QPSK for example the information content of the symbol now changes from 1 bit to 2 bits. At the same time the necessary energy which is required for reliable reception of the symbols increases. In that case the following applies: Eₘᵢₙ=2*E_{b}_{_{—}}ₘᵢₙ.

The energy budget management procedure therefore involves the situation where the energy present can be fully used by the receiver insofar as modulation is adapted to the factors involved and it is not the symbol duration that is varied but the information content within the symbols.

In principle it is always the case that the symbol energy can be converted into a corresponding energy per bit:
Eₛ=log₂(M)·E_{b} (16)

wherein M describes the number of various “states” of the symbol and log₂(M) describes the number of bits per symbol, wherein all states have the same probability. In the general case a different probability can also be considered here.

In generalizing terms it is now assumed that a modulation mode is always used so that the symbols with a higher information content require the energy E_{b}_{_{—}}ₘᵢₙ on statistical average for each bit, as is required for the selected reference cell.

In this embodiment only the modulation of the symbols is varied. The energy radiated from the transmitter (or the base station) is in that case always the same for each subscriber:
E_{symbol}_{_{—}}_{send}=P_{send}·T_{ref}=E_{send}=constant (17)

That seemingly corresponds to the reference case, but in the EBM system the information content of the symbols is altered. That manifests itself if the transmitted energy per bit is specified:

$${E}_{b\_send \_EBM} = \frac{{E}_{send}}{{log}_{2} [ M ( r ) ]} \qquad ( 18 )$$

In accordance with the losses which occur, for a near subscriber that now involves a higher information content, that is to say a large M, while for a subscriber who is further away, that involves a smaller M. In contrast the received energy per bit is always to correspond to the minimum value (29) so that in relation to distance there is a function of the transmitted energy for the subscriber in question.

Equating the two expressions (18) and (29) leads on to a clear description of the modulation to be selected in the transmitter (31), in which respect it may be assumed that the number of discrete “states” of the symbol M(r) can be sufficiently varied to provide a good approximation to the given continuous function.

Each subscriber now requires not a number of symbols but only of bits for the transmission of a predetermined amount of information. Accordingly the energy which an individual subscriber claims is dependent only on the number of bits and the energy of the individual bit so that this involves the integral (32) in total over subscribers with equal rights, for application of energy budget management.

That integral can be easily calculated with the above-specified formulae (33) and affords the expression (24) already previously contained in the general derivation.

Only the designation of the minimum energy has been altered here as here it was necessary to distinguish bit and symbol energy. In contrast (34) still applies for the classical situation. That corresponds exactly to the previously specified general derivation so that finally it can be emphasized that the described energy budget management system can in principle also be optimally implemented by higher-stage modulation.

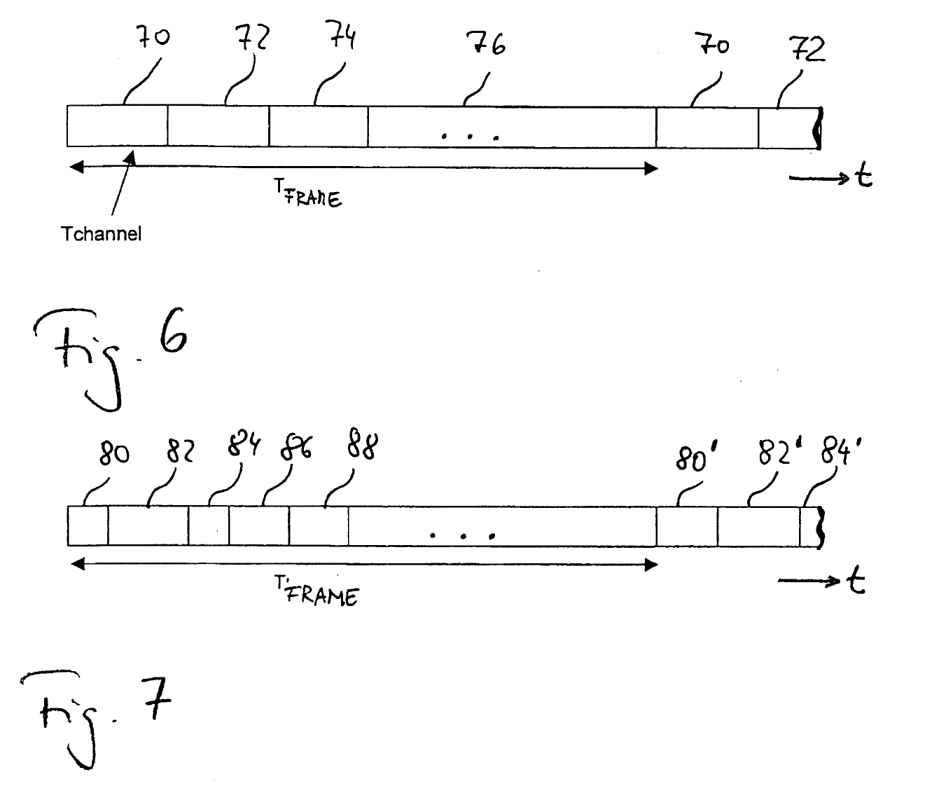

Reference will now be made to FIGS. 6 and 7 to consider a time division multiple access method (TDMA) as a further embodiment.

FIGS. 6 and 7 each show the division of a given period of time T_{FRAME} into time portions 70 through 76 and 80 through 88 and 80′ through 84′ respectively, referred to as time slots. A conventional TDMA method involves separation of the subscribers on the time axis by a given time slot being allocated to each subscriber. Those time slots periodically occur at time intervals T_{FRAME}, after which each subscriber is allocated a time slot afresh. The portion 76 in FIG. 6 characterizes a period of time with a number of further time slots of the duration T_{channel}.

Now, in a network, the channel conditions are different for the individual users so that the EBM method provides that various symbol durations and various modulations must be applied in order to make optimum use of the resources available.

If in that case the number of transmitted bits per time slot is fixed and thus the subscriber is guaranteed an unchanged data rate, then the duration of the time slots is altered dynamically according to the channel conditions. That can be seen in FIG. 7 by reference to the differing width of the time slots 80 through 88 and 80′, 82′ and 84′. The organization of those time slots of differing lengths is relatively simple in TDMA.

In general terms the time duration of a packet is reduced in relation to a reference cell since, as already explained at a number of places above, the classical system is designed for the worst case scenario and all closer stations receive an excessively great power, as FIG. 2 shows. The efficiency of EBM is thus immediately apparent.

Execution of EBM can now be effected for example with a fixed symbol duration and thus unaltered bandwidth by higher-stage modulation so that fewer symbols and thus a shorter time slot is required for the transmission of a defined piece of information. Mention may be made here by way of example of a QAM so that the information content of the symbols can be increased stepwise from QPSK to for example 256 QAM.

In the receiver, the necessary changes to the detector are relatively slight. Besides pure phase detection, an amplitude detector is additionally necessary with QAM.

To determine the optimum symbol for EBM, it is possible here to use simple regulation insofar as firstly the simplest modulation is applied in the access channel and then a higher-stage modulation is applied stepwise, the symbols of which have a higher information content. That information content can then be increased until either the symbol with the greatest information content is used or the transmission quality (determined by the bit error rate) no longer satisfies the demands involved.

Alternatively it would be possible to measure the power of the received signal and, on the basis of that information, to immediately determine the most favorable symbol without going through stepwise regulation.

That optimization is to be effected individually for each subscriber. Then, on the basis of the channel-specific time slot lengths, fresh organization of the TDMA is necessary, in which the time marks for the beginning of the individual time slots are dynamically adapted to the changes in the network.

In that case so many time slots can be allotted until the predetermined time frame T_{FRAME} is optimally filled.

In addition the situation can occur where the energy of the symbols for individual subscribers is too low, due to interference effects or shadowing. In the classical TDMA method no connection is then possible.

In those situations there must additionally be an increase in the length of the symbol duration, for example by the duration being doubled stepwise using the simplest modulation until either the maximum symbol duration is reached or the transmission quality (determined by the bit error rate) satisfies the demands involved.

In that respect the receiver must possibly adjust its matched filter so that the symbol energy present is put to optimum use.

In a combination of the two regulating procedures, the quality of transmission for all subscribers of TDMA is markedly improved by introducing the EBM procedure.

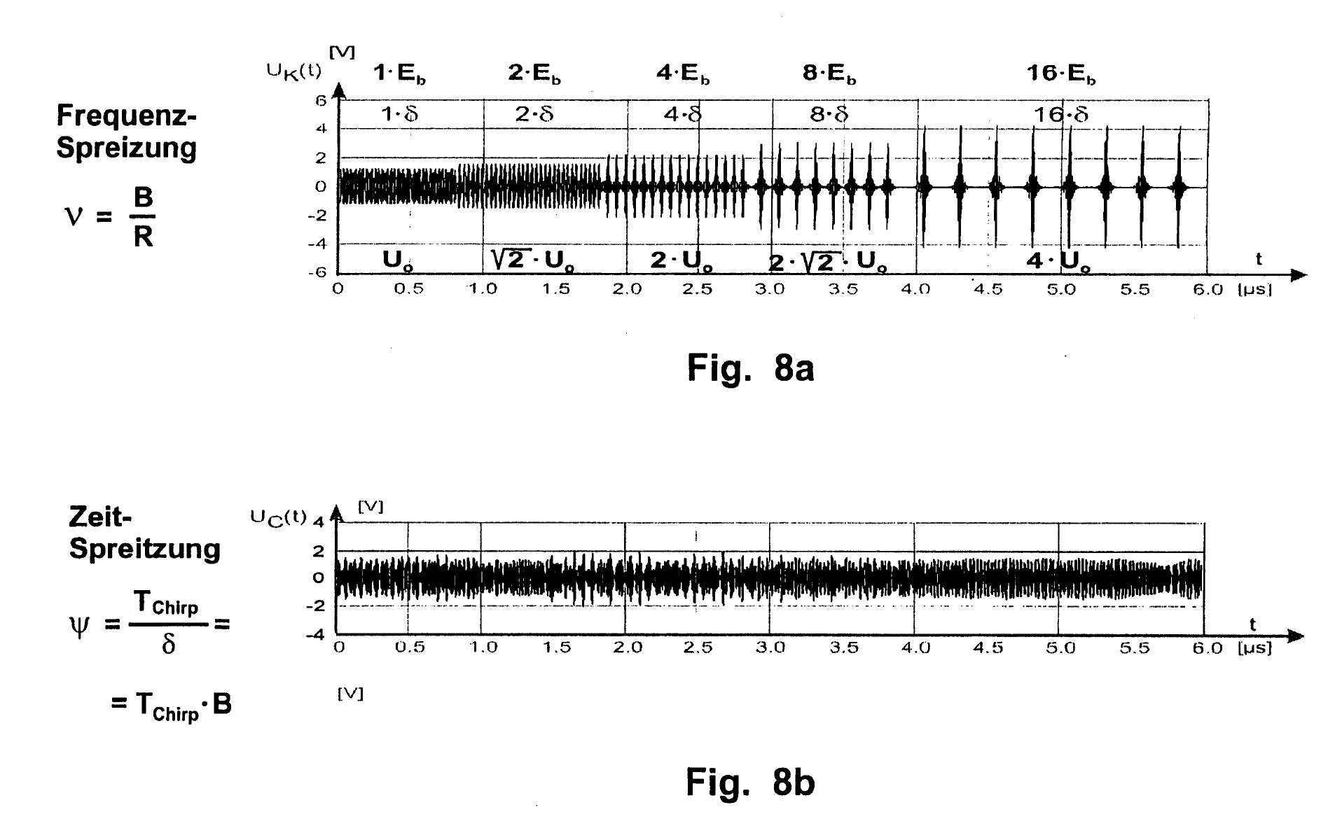

Reference will now be made to FIG. 8a to describe application of EBM to an MDMA method.

The production of long symbols in a transmitter often does not cause any difficulties. In contrast the receiver may suffer from major problems in receiving long symbols of small bandwidth, particularly if FDMA is used and the frequency must be accurately hit.

In general it is more favorable here to spread the symbols and to use a correlation receiver. That applies equally for all pseudo-noise sequences (maximum length sequences (m-sequences), gold codes and so forth), as also for all kinds of chirp signals.

Those receiver types also basically correspond to the classical matched filter which is used for optimum transmission.

In consideration of dynamic energy budget management and thus symbol duration variation that filter also has to be dynamically adapted. That is also possible in an implementation in the form of software radio.

In that respect the chirp signals assume a particular position. There it is possible for the individual signals to be superimposed in respect of time so that the physical symbols are of a different time duration from the logical symbols.

In the receiver, those symbols are separated from each other again by the compression filter and shaped to provide short pulses which maintain the spacing n·δ[s] from each other.

In that case it is possible for the duration of the physical symbols T_{Chirp}>>δ to be kept constant if the duration T_{symbol} and thus the data rate of the logical symbols is altered by energy budget management.

As due to the chirp signals the bandwidth B[Hz] used always remains the same, there is only a change in the contained spread gain which is calculated as B·n·δ=n if the time duration δ of the compressed chirp signals corresponds to the reciprocal of the bandwidth B.

The decisive advantage in that respect is that the same correlation filter or the same correlation process can always be used in the receiver.

That situation is shown in FIG. 8a. There the minimum logical symbol duration is identified by δ[s]. That value corresponds to the reciprocal of the bandwidth B[Hz]. Frequency spreading is therefore initially 1 and is increased stepwise to 2, 4, 8 and so forth, by the physical pulse duration δ being maintained and the repetition rate being reduced stepwise.

In that case the energy contained in the physical symbols increases stepwise as the amplitude of the pulses rises.

Time spreading is effected before those signals are emitted so that the transmission signal is of an almost constant amplitude and thus constant transmission power. That spreading action can be effected for example with dispersive group delay-time filters so that each narrow pulse is replaced by a chirp signal of predetermined duration and bandwidth.

A complementary process takes place in the receiver so that the chirp signals are compressed to narrow pulses again.

That form of time spreading has already been described in detail in patent specification DE 199 37 706 and can also be advantageously used in that form for application of the energy budget management procedure.

The amount of the transmission symbols in that specific case of MDMA is distinguished here in that n different symbols are available, n≦T_{chirp}/δ, the energy of the symbols are integral multiples of the shortest symbols, the spread factor is also increased simultaneously with energy and higher-stage modulation processes (for example PSK or QAM or ASK . . . ) are superimposed on the shortest symbol so that there is a number of symbols with a higher information content.

To determine the optimum symbol for EBM it is possible here to use simple regulation insofar as firstly the symbols which are longest and most robust by virtue of the great spreading effect, with the greatest energy, are used in the access channel and symbols with a higher data rate are tested stepwise until either the maximum data rate is reached or the transmission quality (for example determined by the bit error rate) no longer satisfies the demands involved.

In the situation where the shortest symbols are used, a higher-stage modulation process is then additionally used in order to allocate a higher information content to each symbol. That information content can be increased until either the symbol with the highest information is used or the transmission quality (determined for example by the bit error rate) no longer satisfies the demands involved.

Alternatively it would be possible to measure the power of the received signal and, on the basis of that information, to determine the most favorable symbol immediately without passing through stepwise regulation.

That energy budget optimization is necessary for each subscriber within a network as the channel properties generally differ considerably.

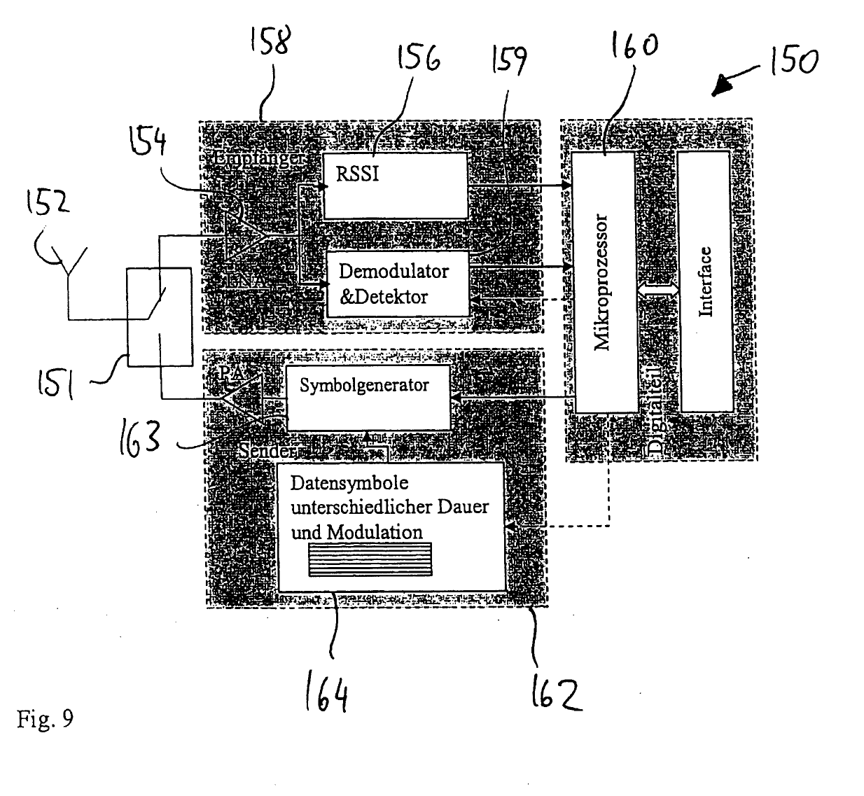

FIG. 9 shows an embodiment of a transmitter-receiver arrangement 150 for wireless connection with energy budget management.

A signal received by an antenna 152 is firstly amplified in a low-noise amplifier 154 (LNA) and then in a receiver 158 passed at the same time to an RSSI detector 156 and a demodulator and detector unit 159. A microprocessor 160 can calculate the received energy from the signal delivered by the RSSI detector 156 and in turn determine therefrom the optimum signal which, with the given reception quality, maintains the highest data rate and at the same time can be sufficiently reliably received. The output signal of the demodulator and detector unit 159 is also passed to the microprocessor 160 for further processing.

Then, the kind of symbol used can be agreed between two stations in a handshake protocol, in which case the most reliable connection can be selected during the phase of that matching operation, that is to say transmission is effected with the longest symbols.

In accordance with that procedure the transmitter-receiver arrangement in FIG. 9 also has a transmitter 162 which is connected to the antenna 152 and which is also connected to the microprocessor 160. Optionally, the assembly may include a memory 164 with stored parameters or signal patterns of data symbols of different duration and modulation. The transmitter includes a symbol generator 163 which is also connected at the input side to the microprocessor and to the output side of which is connected an amplifier (PA).

Two intercommunicating transmitter-receiver arrangements should preferably be of a flexible design configuration. It is even possible to achieve the optimum results by the transmitter 162 emitting one kind of symbol and the receiver 158 of the same assembly receiving a different kind of symbol in the context of a connection.

A transmitting-receiving change-over switch 151 is optionally provided in order to switch over between the transmitting mode and the receiving mode.

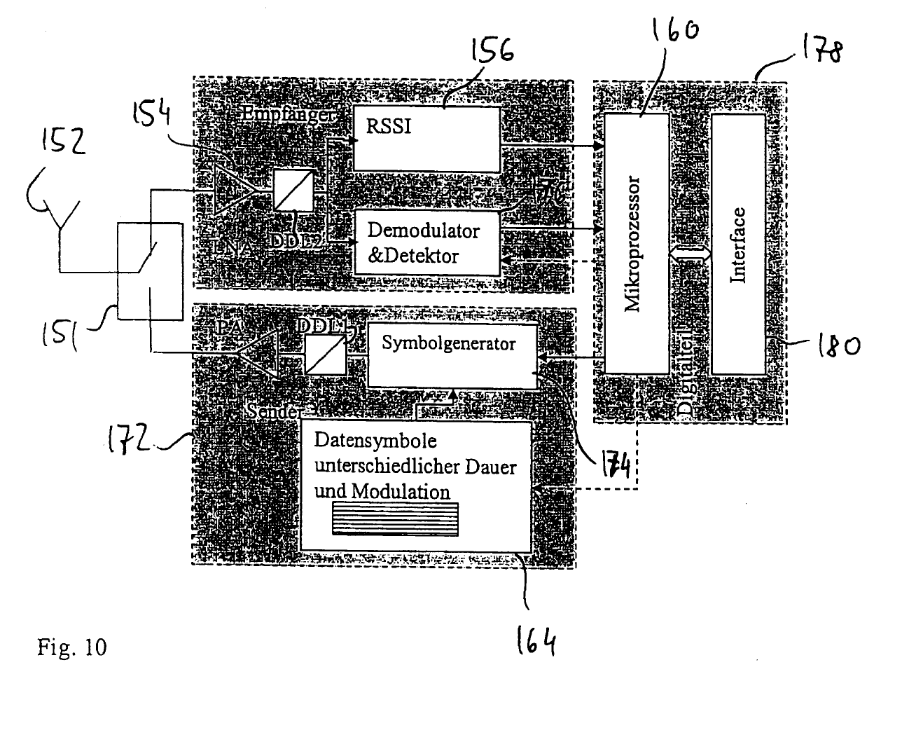

FIGS. 10 through 13 show variants of the embodiment of FIG. 9. The description hereinafter of those variants is concentrated on the differences in relation to the arrangement of FIG. 9. The same references are used for units which correspond in the comparison with the arrangement of FIG. 9.

In the digital portion 178, the microprocessor 160 can be programmed and controlled by way of a connected interface 178.

The transmitter and receiver arrangement in FIG. 10 is additionally designed for chirp signal production. For that purpose the receiver 170 and the transmitter 172 have mutually complementary dispersive delay sections DDL2 and DDL1. In the transmitter a symbol generator 174 controlled by the microprocessor 160 is connected to the input side of the delay section DDL1. In the receiver 170, a demodulator and detector block 176 is connected to the output side of the delay section DDL2.

Symbols produced are transformed into chirp signals in the transmitter 172 by means of the delay section DDL1. They use the full available bandwidth. In the receiver, the transformation is reversed by means of the complementary filter DDL2. The elongated chirp signals are converted to short signal peaks.

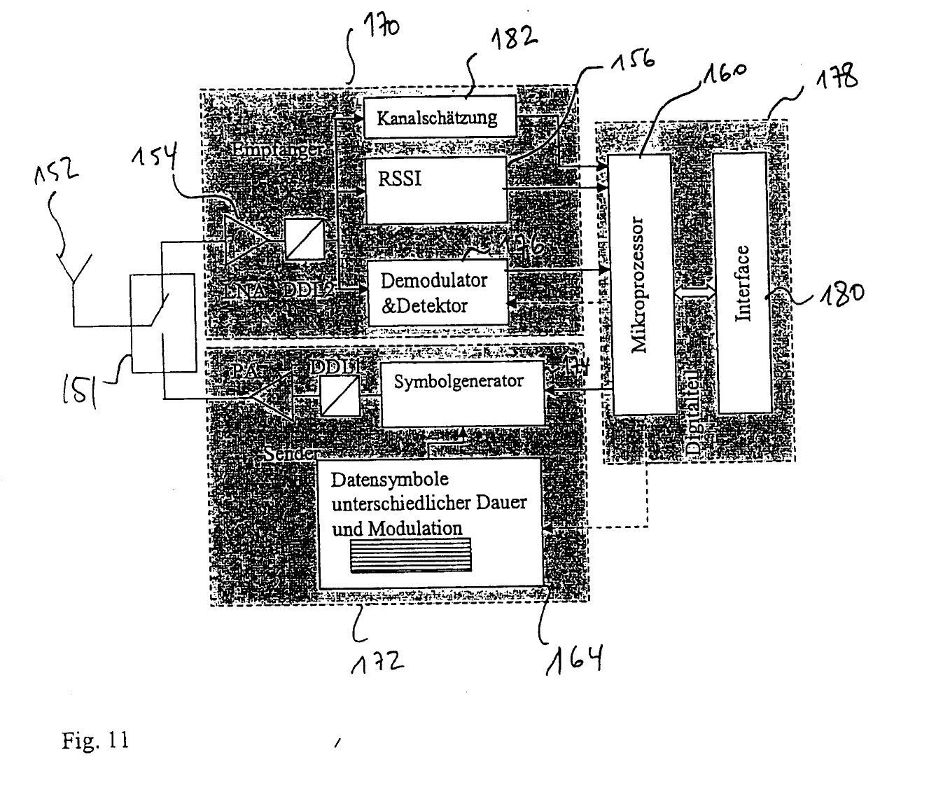

The transmitter and receiver arrangement in FIG. 11 differs from that shown in FIG. 10 by a channel estimation unit 182 which is additionally provided in the receiver portion 170. In that way it is possible to optimize the operation of determining the optimum energy of the signals to be transmitted. Thus the necessary spreading effect as well as the energy required in that case can be directly estimated without testing all available signals in a tedious process.

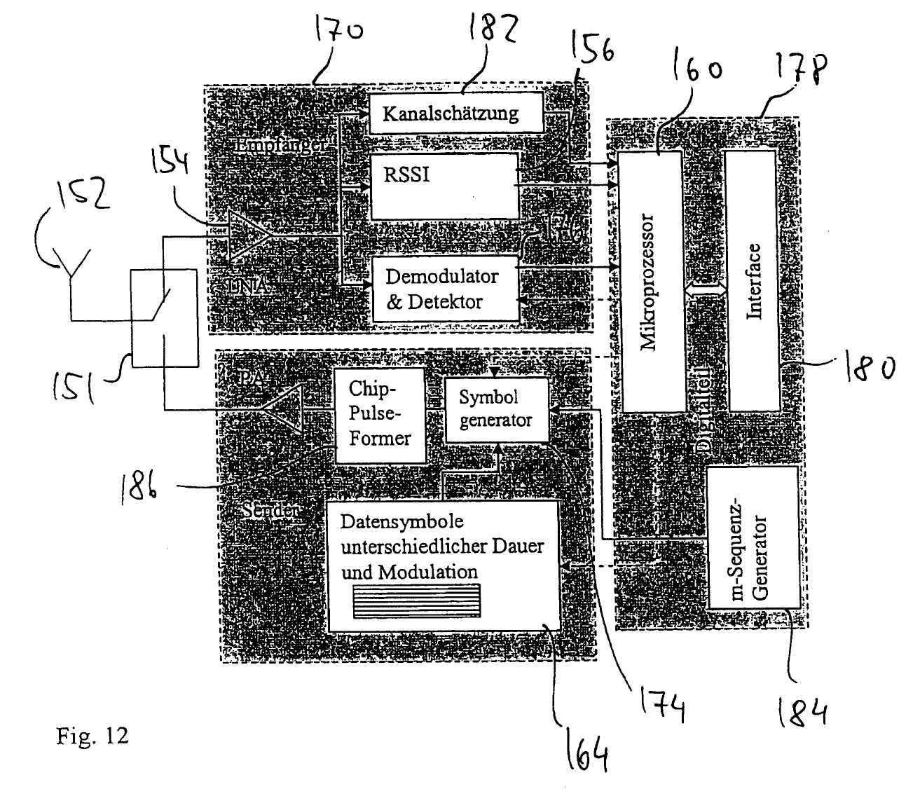

FIG. 12 shows a variant which, in comparison with the arrangement shown in FIG. 11, provides for the production of pseudo-noise sequence for spreading the signals. For that purpose an m-sequence generator 184 which is connected on the input side of the symbol generator 174 is provided in the digital portion 178. The stored possible symbol durations are now a multiple of a chip duration. Prior to transmission of the symbols, the required part of the m-sequence is superimposed on the symbol in the symbol generator 174 so that the symbols are spread to the maximum bandwidth. Pulse shaping is additionally provided in a pulse shaping unit 186 so that the predetermined bandwidth is observed.

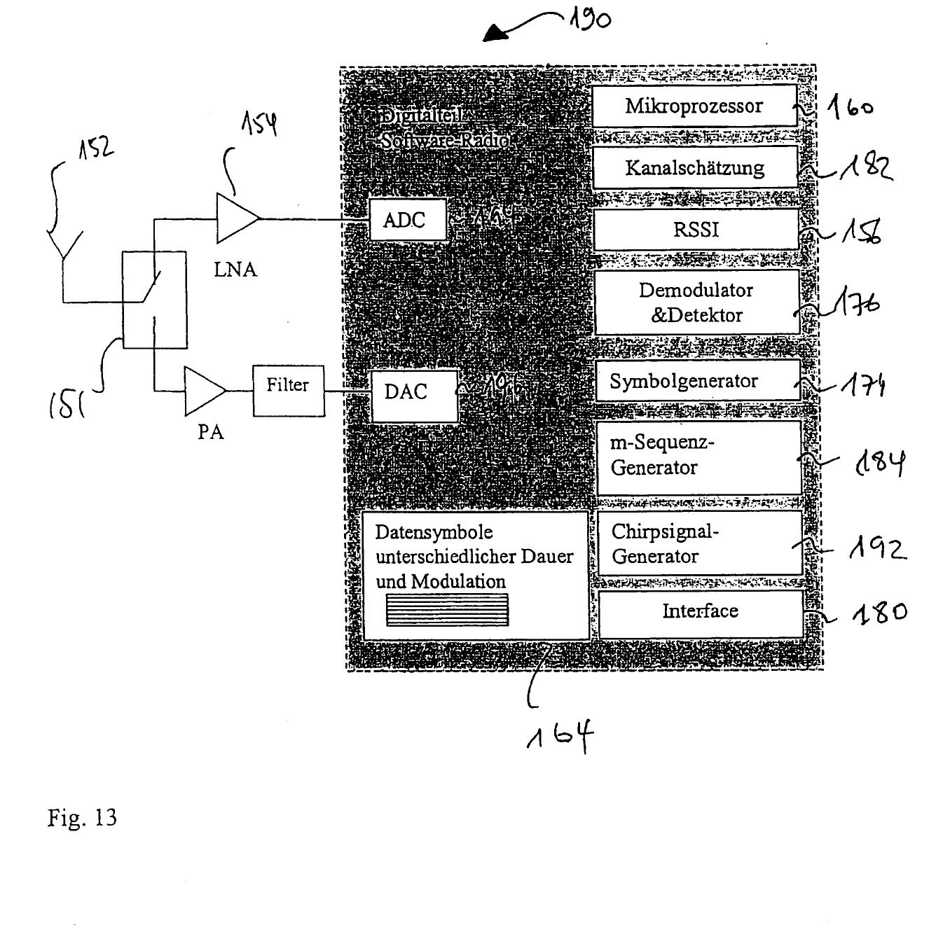

FIG. 13 shows a variant in the form of a transceiver module 190 in the form of software radio which has programmable functional blocks which in respect of their function correspond to the above-described unit of the transmitter-receiver arrangements described there.

As a further difference in relation to the arrangements in the preceding Figures, this arrangement has a chirp signal generator 192. An analog-digital converter converts the incoming analog signals on the receiver side into digital signals for further processing in the digital portion. A digital-analog converter 196 is correspondingly provided for transmission.

APPENDIX 1
Table overview of the parameters and symbols used

| Parameter/symbol | Unit | Description |
|---|---|---|
| ∘-● | | symbol which characterizes the Fourier |
| | | transform |
| [symbol] | | symbol which indicates the equivalence |
| | | of two equations |
| [symbol] | | symbol which indicates a logical |
| | | consequence |
| ! = | | symbol indicating a postulate, here a |
| | | postulated identity |
| α | | propagation coeffcient |
| δ | [s] | time duration of the compressed chirp |
| | | signal |
| λ | [mm] | wavelength |
| φ | [rad] | azimuth angle |
| ψ | [W/W] | spread gain |
| ω | [Hz] | angular frequency |
| B | [Hz] | bandwidth |
| A | [m²] | area |
| BER | | bit error rate |
| BLER | | block error rate |
| C | [bits/s] | channel capacity |
| E | [Ws] | energy |
| E_{b} | [Ws] | energy of a bit |
| E_{b}_min | [Ws] | minimum energy required to receive |
| | | a bit |
| E_{b}_receive_EBM | [Ws] | energy in EBM per received bit |
| E_{b}_send_EBM | [Ws] | energy in EBM per transmitted bit |
| E_{BS}_EBM | [Ws] | energy radiated in total by a base |
| | | station, for the design of a cell |
| | | using EBM |
| E_{BS}_classical | [Ws] | energy radiated in total by a base station |
| | | for a classical design of a cell |
| ED | [Ws/Hz/s] | energy density (for example in |
| | | accordance with Wigner-Ville) |
| Eₘᵢₙ | [Ws] | minimum energy per symbol |
| | | required for reception |
| E_{receive} | [Ws] | received energy per symbol |
| Eₛ | [Ws] | symbol energy |
| ESD | [[Ws/Hz] | energy spectral density |
| E_{send} | [Ws] | energy of the transmitted symbol |
| E_{send}_EBM | [Ws] | energy of the transmitted symbol using |
| E_{symbol}_send | [Ws] | energy of the transmitted symbol |
| | | EBM |
| f1 | [Hz] | lower limit frequency of a spectrum |
| f2 | [Hz] | upper limit frequency of a spectrum |
| f_{active} | [1/m²] | density of the active users per unit |
| | | of area |
| f_{active}_EBM | [1/m²] | density of the active users per |
| | | area of unit using EBM |
| FER | | frame error rate |
| f_{g} | [Hz] | upper limit frequency in the baseband |
| M | | number of various “states” of a symbol |
| N | [W] | noise power |
| n | | number of various symbols in MDMA |
| | | with different symbol durations |
| N₀ | [W/Hz] | noise power density |
| N_{channel} | | number of active channels in a cell |
| N_{channel}_EBM | | number of active channels in a cell |
| | | using EBM |
| P_{receive} | [W] | received power per symbol |
| P_{send} | [W] | maximum transmission power |
| r | [m] | distance variable |
| r_{cell} | [m] | radius of a cell |
| r_{EBM} | [m] | radius of a cell when using EBM |
| R_{ref} | [bits/s] | data rate per subscriber in reference cell |
| r_{ref} | [m] | radius of a reference cell |
| Rᵤₛₑᵣ | [bits/s] | data rate per user |
| S | [W] | signal power at receiving end |
| t₁ | [s] | moment in time |
| t₂ | [s] | moment in time |
| t₃ | [s] | moment in time |
| T | [s] | minimum symbol duration with |
| | | respect to bandwidth B |
| T_{Channel} | [s] | duration of a time slot in TDMA |
| T_{Chirp} | [s] | time duration of a chirp signal |
| T_{FRAME} | [S] | frame time duration |
| T_{ref} | [s] | symbol duration in a reference cell |
| T_{symbol} | [s] | time duration of a symbol |
| T_{symbol}_EBM | [s] | time duration of a symbol using EBM |

APPENDIX 2
Formulae of the Calculations Relating to FIG. 5

$$\begin{matrix}{E}_{receive} ( r ) = \frac{{E}_{send}}{1 + {( \frac{4 \cdot π \cdot r}{λ} )}^{2}} & ( 19 ) \\ \begin{matrix}{E}_{min} = {P}_{receive} ( {r}_{ref} ) \cdot {T}_{ref} \\ = \frac{{P}_{send} \cdot {T}_{ref}}{1 + {( \frac{4 \cdot π \cdot {r}_{ref}}{λ} )}^{2}} \\ = \frac{{E}_{send}}{1 + {( \frac{4 \cdot π \cdot {r}_{ref}}{λ} )}^{2}}\end{matrix} & ( 20 ) \\ {f}_{active} ( r , φ ) = \frac{{N}_{channel}}{π \cdot {r}_{ref}^{2}} & ( 21 ) \\ {E}_{send\_EBM} ( r ) = [ 1 + {( \frac{4 \cdot π \cdot {r}_{ref}}{λ} )}^{2} ] \cdot {E}_{min} & ( 22 ) \\ {E}_{BS\_EBM} = {\int \int }_{A} {E}_{send\_EBM} ( r ) \cdot {f}_{active} ( r , φ ) \cdot ⅆ A & ( 23 ) \\ {E}_{BS\_EBM} ( {r}_{cell} ) = \begin{matrix}\frac{1}{2} {E}_{min} \cdot \frac{{N}_{channel\_EBM}}{{r}_{ref}^{2}} \cdot \\ [ 2 + {( \frac{4 \cdot π \cdot {r}_{ cell}}{ λ} )}^{2} ] \cdot {r}_{ cell}^{ 2}\end{matrix} & ( 24 ) \\ 2 << {( \frac{4 \cdot π \cdot {r}_{ref}}{ λ} )}^{2} & ( 25 ) \\ \begin{matrix}{f}_{active} ( r , φ ) = \frac{{N}_{channel}}{π \cdot {r}_{ref}^{2}} \\ = {f}_{active\_EBM} ( r , φ ) \\ = \frac{{N}_{channel\_EBM}}{π \cdot {r}_{ref}^{2}}\end{matrix} & ( 26 ) \\ \begin{matrix}{E}_{BS\_EBM} ( {r}_{cell} ) = \frac{1}{2} {E}_{min} \cdot \frac{{N}_{channel}}{{r}_{ref}^{2}} \cdot [ 2 + {( \frac{4 \cdot π \cdot {r}_{cell}}{ λ} )}^{2} ] \cdot {r}_{cell}^{2} \\ {=}^{!} {E}_{BS\_classical}\end{matrix} & ( 27 ) \\ \frac{1}{2} \frac{2 + {( \frac{4 \cdot π \cdot {r}_{EBM}}{ λ} )}^{2}}{1 + {( \frac{4 \cdot π \cdot {r}_{ref}}{ λ} )}^{2}} \cdot \frac{{r}_{EBM}^{2}}{{r}_{ref}^{2}} = 1 & ( 28 ) \\ {E}_{b\_receive \_EBM} = \frac{{E}_{b\_send \_EBM}}{1 + {( \frac{4 \cdot π \cdot r}{ λ} )}^{2}} {=}^{!} {E}_{b\_min} & ( 29 ) \\ {E}_{b\_send \_EBM} ( r ) = [ 1 + {( \frac{4 \cdot π \cdot r}{ λ} )}^{2} ] \cdot {E}_{b\_min} & ( 30 ) \\ {log}_{2} [ M ( r ) ] = \frac{1}{1 + {( \frac{4 \cdot π \cdot r}{ λ} )}^{2}} \cdot \frac{{E}_{send}}{{E}_{b\_min}} . & ( 31 ) \\ {E}_{BS\_EBM} = {\int \int }_{A} {E}_{b\_send \_EBM} ( r ) \cdot {f}_{active} ( r , φ ) \cdot ⅆ A . & ( 32 ) \\ {E}_{BS\_EBM} ( {r}_{cell} ) = \begin{matrix}\frac{1}{2} {E}_{b\_min} \cdot \frac{{N}_{channel\_EBM}}{{r}_{ref}^{2}} \cdot \\ [ 2 + {( \frac{4 \cdot π \cdot {r}_{ cell}}{ λ} )}^{2} ] \cdot {r}_{ cell}^{ 2} ,\end{matrix} & ( 33 ) \\ {E}_{BS\_classical} = {N}_{channel} \cdot {E}_{send} = [ 1 + {( \frac{4 \cdot π \cdot {r}_{ ref}}{ λ} ‵ )}^{2} ] \cdot {E}_{b\_min} & ( 34 )\end{matrix}$$

1. A method, comprising transmitting a plurality of symbols each having at least one bit from a transmitter to at least one receiver using at least one channel and a predetermined transmission power,
wherein the symbols are transmitted with a receiver-specific transmission energy which on the part of the receiver results in the reception of the symbol with a reception energy which corresponds to an upper limit value associated with the receiver or a lower value of an error recognition rate in comparison with the upper limit value, and
wherein to achieve the receiver-specific transmission energy and at the same time a bit rate which is as high as possible in dependence on the currently prevailing transmission conditions between the transmitter and the receiver the symbol duration or the number per symbol of transmitted bits or the symbol duration and the number per symbol of transmitted bits are adapted.

2. A method of organizing a network, comprising transmitting a plurality of symbols each with at least one bit from a transmitter to at least one receiver using at least one channel and a predetermined transmission power,
wherein the symbols are transmitted with a receiver-specific transmission energy which on the part of the receiver leads to the reception of the symbol with a reception energy which corresponds to an upper limit value associated with the receiver or a lower value of an error recognition rate,
wherein in dependence on the currently prevailing transmission conditions between the transmitter and each individual receiver to achieve the receiver-specific transmission energy and at the same time a bit rate which is as high as possible the symbol duration, or the number per symbol of transmitted bits, or the symbol duration and the number per symbol of transmitted bits are adapted.

3. A method as set forth in claim 1 wherein exclusively the symbol duration is adapted.

4. A method as set forth in claim 1 comprising a step of selecting between three available adaptation options, namely adaptation of the symbol duration, adaptation of the number per symbol of transmitted bits and adaptation both of the symbol duration and also the number per symbol of transmitted bits.

5. A method as set forth in claim 1 wherein in channel-specific fashion on time average the predetermined transmission power and/or the radiated electrical field strength and/or the radiated magnetic field strength and/or the spectral power density in the context of admissible power radiation or a parameter correlated with one or more of said parameters assumes a limit value corresponding to the maximum possible transmission energy per unit of time in the context of admissible radiation.

6. A method as set forth in claim 1 wherein the predetermined transmission power is at a maximum on time average in the context of the technical design of the transmitter.

7. A method as set forth in claim 1 wherein the transmission power can be predetermined.

8. A method as set forth in claim 1 comprising an additional step of ascertaining a currently prevailing value in respect of the reception energy with a given transmission energy.

9. A method as set forth in claim 1 wherein an RSSI measurement (radio signal strength indicator) in respect of the received power is carried out on the part of the receiver and a signal dependent on the measurement result is transmitted to the transmitter.

10. A method as set forth in claim 1 comprising an alternative or additional step of ascertaining a currently prevailing value in respect of the error recognition rate.

11. A method as set forth in claim 10 wherein the error recognition rate is ascertained by determining the number of errors within a received data frame.

12. A method as set forth in claim 10 wherein the error recognition rate is ascertained by averaging the number of errors in a plurality of data frames.

13. A method as set forth in claim 12 wherein the error recognition rate is ascertained by means of the number of negative receipt signals from the receiver over a predetermined period of time.

14. A method as set forth in claim 1 wherein the error recognition rate is a bit error rate (BER), a block error rate (BLER) or a frame error rate (FER).

15. A method as set forth in claim 1 wherein adaptation of the symbol duration is effected in dependence on the currently prevailing value of the error recognition rate at the receiver end or a currently prevailing magnitude at the receiver end of the noise power density.

16. A method as set forth in claim 1 wherein the receiver communicates to the transmitter the currently prevailing error recognition rate or the currently prevailing magnitude of the noise power density.

17. A method as set forth in claim 1 wherein the transmitter estimates the currently prevailing error recognition rate at the receiver end or the currently prevailing magnitude of the noise power density.

18. A method as set forth in claim 1 wherein the symbol duration or the number of bits contained in a symbol or both is adjusted down dynamically in dependence on the currently prevailing transmission conditions between transmitter and receiver in an existing connection or an ongoing data traffic without the connection or the data traffic being interrupted.

19. A method as set forth in claim 1 wherein the change in the symbol duration takes place continuously in respect of time, alternatively quasi-continuously, alternatively at predetermined time intervals.

20. A method as set forth in claim 1 wherein the symbol duration is adapted in channel-specific fashion, that is to say individually on each channel used.

21. A method as set forth in claim 1 wherein the symbol duration is restricted towards short symbol duration values in channel-specific fashion by the bandwidth of the channel.

22. A method as set forth in claim 1 wherein the symbol duration is determined from a continuous value spectrum.

23. A method as set forth in claim 1 wherein the symbol duration is determined from a discrete value spectrum, wherein the discrete value spectrum contains the integral multiples of a symbol duration which is the shortest possible in channel-specific relationship.

24. A method as set forth in claim 1 wherein the symbol duration T_{symbol} is determined at the transmitter end in accordance with the formula:
$${T}_{symbol} = \frac{{E}_{min} \cdot {( r / {r}_{0} )}^{α}}{{P}_{send}}$$
wherein Eₘᵢₙ is the reception energy corresponding to the upper limit value associated with the receiver in respect of the error recognition rate, P_{send} is the maximum transmission power, r is the distance between transmitter and receiver, r₀ is a reference distance and a is a propagation coefficient.

25. A method as set forth in claim 1 wherein the selection of the number per symbol of transmitted bits is effected in dependence on the currently prevailing value of the error recognition rate at the receiver end or on a currently prevailing magnitude at the receiver end at the noise power density.

26. A method as set forth in claim 1 wherein the number per symbol of transmitted bits is adapted in channel-specific relationship.

27. A method as set forth in claim 1 wherein adaptation of the number per symbol of transmitted bits is effected when a symbol duration which is shortest in channel-specific relationship is already used.

28. A method as set forth in claim 1 wherein a type of symbol with the highest possible number of bits is selected for transmission, which at the receiver end does not cause the upper limit value of the error recognition rate to be exceeded.

29. A method as set forth in claim 1 wherein the symbols are transmitted divided up to a respective sequence of chips.

30. A method as set forth in claim 29 wherein the symbols are spread in respect of frequency by being modulated with a noise or pseudo-noise sequence, the noise or pseudo-noise sequence being known to the receiver.

31. A method as set forth in claim 30 wherein the noise or pseudo-noise sequence is dynamically adapted to the selected symbol duration.

32. A method as set forth in claim 1 wherein the symbols are transmitted in such a way that the available channel bandwidth is fully used.

33. A method as set forth in claim 1 wherein the symbols are transmitted spread in respect of frequency.

34. A method as set forth in claim 1 wherein the symbols are transmitted in the form of a chirp signal.

35. A method as set forth in claim 34 wherein chirp signals from the transmitter, which are intended for a respective receiver, are superimposed in respect of time.

36. A method as set forth in claim 35 wherein the total of the transmission powers, radiated in a moment in time, of the mutually superimposed chirp signals is equal to the maximum admissible transmission power on the respective channel.

37. A method as set forth in claim 1 wherein the symbols are transmitted in the form of a CDMA sequence.

38. A method as set forth in claim 1 wherein the symbols are transmitted in the frame of a FDMA method.

39. A method as set forth in claim 38 wherein division into FDMA channels is effected dynamically in such a way that a lower bandwidth is allocated to receivers with good channel transmission conditions.

40. A method as set forth in claim 1 wherein a TDMA method is used on at least one channel.

41. A method as set forth in claim 1 wherein the transmitter is a mobile terminal of a user and prior to the transmission of the symbols to a base station receives from the base station information about a frequency band to be used for the transmission.

42. A method as set forth in claim 1 wherein a base station operating as a receiver checks incoming signals from a mobile terminal operating as a transmitter with a plurality of modulation modes and uses a modulation mode recognized as correct for reception of the signals from the mobile terminal.

43. A method as set forth in claim 1 wherein a base station operating as a receiver receives incoming signals by means of a plurality of receivers, wherein a modulation mode is associated with each receiver and a mobile terminal operating as a transmitter uses one of the modulation modes available at the transmitter end for transmission of symbols to the base station.

44. A transmitter adapted for carrying out a method as set forth in claim 1.

45. A transmitter for carrying out a method as set forth in claim 1, and comprising
a transmitting unit which is adapted to produce signals representing logic symbols (hereinafter referred to as symbols) and emitting same, wherein a logic symbol represents either a bit or a plurality of bits, and
a control unit which is adapted on the basis of items of information present about currently prevailing transmission conditions between the transmitter and a receiver of the symbols to produce and deliver control signals which prescribe for the transmitting unit a receiver-specific transmission energy which corresponds to an upper limit value in respect of a error recognition rate associated with the receiver or a lower value of the error recognition rate than the upper limit value,
wherein the control unit is additionally adapted, for the purposes of achieving the receiver-specific transmission energy and at the same time a bit rate which is as high as possible in dependence on the currently prevailing transmission conditions between the transmitter and the receiver, to produce and deliver control signals which prescribe for the transmitting unit the use of symbols with a suitably adapted symbol duration, or with a suitably adapted number per symbol of transmitted bits, or with a suitably adapted symbol duration and a suitably adapted number per symbol of transmitted bits.

46. A transmitter as set forth in claim 44 wherein the control unit is adapted solely in accordance with the alternative, for production of the receiver-specific transmission energy and at the same time a bit rate which is as high as possible in dependence on the currently prevailing transmission conditions between transmitter and receiver to produce and deliver control signals which prescribe for the transmitting unit the use of symbols with a suitably adapted symbol duration.

47. A transmitter as set forth in claim 44 wherein the control unit is adapted in dependence on the currently prevailing transmission conditions between transmitter and receiver to select one or more of a number of available adaptation options and to produce and deliver a control signal indicating the selection made, wherein the adaptation options include adaptation of the symbol duration, adaptation of the number per symbol of transmitted bits and adaptation both of the symbol duration and also the number per symbol of transmitted bits.

48. A transmitter as set forth in claim 44 wherein the control unit is adapted to control the transmitting unit in such a way that in channel-specific relationship on time average the transmission power and/or the radiated electrical field strength and/or the radiated magnetic field strength and/or the spectral power density in the context of admissible power radiation is equal to a predetermined maximum value or is a maximum within the limits of the technical design of the transmitter or a parameter correlated with one or more of said parameters assumes a limit value corresponding to the maximum possible transmission energy per unit of time in the context of admissible radiation.

49. A transmitter as set forth in claim 44 wherein the control unit is adapted to estimate the currently prevailing error recognition rate on the part of the receiver or the currently prevailing magnitude of the noise power density.

50. A transmitter as set forth in claim 44 wherein the control unit is adapted to re-determine the symbol duration or the number of bits contained in a symbol or both in dependence on currently prevailing transmission conditions between transmitter and receiver dynamically in an existing connection or an ongoing data traffic and to prescribe same for the transmitting unit by means of suitable control signals and that the transmitting unit is adapted to effect the prescribed adaptations without an interruption in the connection or the data traffic.

51. A transmitter as set forth in claim 44 wherein the control unit is adapted to re-determine the symbol duration continuously in respect of time, alternatively quasi-continuously or alternatively at predetermined time intervals.

52. A transmitter as set forth in claim 44 wherein the control unit is adapted to determine the symbol duration in channel-specific fashion, that is to say individually on each channel used.

53. A transmitter as set forth in claim 44 wherein the control unit is adapted to determine the symbol duration T_{symbol} in accordance with the formula:
$${T}_{symbol} = \frac{{E}_{min} \cdot {( r / {r}_{0} )}^{α}}{{P}_{send}}$$
wherein Eₘᵢₙ is the reception energy corresponding to the upper limit value of the error recognition rate which is associated with the receiver, P_{send} is the maximum transmission power, r is the distance between transmitter and receiver, r₀ is a reference distance and a is a propagation coefficient.

54. A transmitter as set forth in claim 44 wherein the control unit is adapted to effect the choice of the number per symbol of transmitted bits in dependence on the currently prevailing value of an error recognition rate at the receiver end or on a currently prevailing magnitude of the noise power density at the receiver end.

55. A transmitter as set forth in claim 44 wherein the control unit is adapted to adapt the number per symbol of transmitted bits in channel-specific relationship.

56. A transmitter as set forth in claim 44 wherein the control unit is adapted to effect adaptation of the number per symbol of transmitted bits when a symbol duration which is shortest in channel-specific relationship is already being used.

57. A transmitter as set forth in claim 44 wherein the control unit is adapted to select that type of symbol with the highest possible number of bits for transmission, which at the receiver end does not allow the upper limit of the error recognition rate to be exceeded.

58. A transmitter as set forth in claim 44 wherein the transmitting unit is adapted to emit the symbols distributed to a respective sequence of chips.

59. A transmitter as set forth in claim 44 wherein the transmitting unit is adapted to emit the symbols spread in respect of frequency insofar as it modulates them with a noise or pseudo-noise sequence which is predetermined by the control unit, the noise or pseudo-noise sequence being known to the receiver.

60. A transmitter as set forth in claim 44 wherein the control unit is adapted to adapt the noise or pseudo-noise sequence to be used by the transmitting unit dynamically to the selected symbol duration.

61. A transmitter as set forth in claim 44 wherein the control unit is adapted to actuate the transmitting unit for emission of the symbols in such a way that the available channel bandwidth is fully used.

62. A transmitter as set forth in claim 44 wherein the transmitting unit is adapted to emit the symbols spread in respect of frequency.

63. A transmitter as set forth in claim 44 wherein the transmitting unit is adapted to emit the symbols in the form of a chirp signal.

64. A transmitter as set forth in claim 44 wherein the transmitting unit is adapted to superimpose in respect of time the chirp signals intended for a respective receiver.

65. A transmitter as set forth in claim 64 wherein the total of the transmission powers, radiated at a moment in time, of the mutually superimposed chirp signals is equal to the maximum admissible transmission power on the respective channel.

66. A transmitter as set forth in claim 44 wherein the transmitting unit is adapted to transmit the symbols in the form of a CDMA sequence or in the frame of a FDMA method or in the frame of a TDMA method.

67. A transmitter as set forth in claim 44 wherein the control unit is adapted in dependence on the currently prevailing transmission conditions between transmitter and receiver to produce and deliver a control signal which prescribes for the transmitting unit the use of one of a plurality of available multiple access methods in the communication with said receiver.

68. A transmitter as set forth in claim 44 wherein the transmitting unit is connected to a data memory which contains transmission parameters or signal patterns of different symbol types.

69. A transmitter as set forth in claim 44 with a dispersive delay section for signal spreading.

70. A transmitter as set forth in claim 44 comprising a sequence generator connected to the transmitting unit and adapted to produce a m-sequence for signal spreading.

71. A transmitter as set forth in claim 44 wherein signals which can be emitted are stored in a memory or can be read out of a shift register structure.

72. A transmitter as set forth in claim 44 wherein the transmitting unit is adapted to produce any signal to be emitted by execution of one or more algorithms which are implemented in the form of a corresponding circuit or in the form of software and to produce the respective signal which is to be currently emitted in dependence on control signals from the control unit.

73. A transmitter as set forth in claim 44 wherein the transmitting unit has a signal sequencer and an IQ modulator unit connected on the output side thereof, and is adapted to pass a signal to be emitted, after the production thereof, to the signal sequencer and then to the IQ modulator unit and then to convert it directly into the carrier band.

74. A transmitter as set forth in claim 44 wherein the transmitting unit is adapted to produce signals to be transmitted internally digitally and wherein the transmitting unit has a digital-analog converter to which the internally produced digital signals are passed prior to radiation.

75. A transmitter as set forth in claim 44 with a programmable transmitter structure (software radio).

76. A transmitter as set forth in claim 75 wherein the transmitter structure is dynamically variable.

77. A transmitter as set forth in claim 44 comprising a channel estimation unit.

78. A transmitter-receiver arrangement comprising a transmitter device and a receiver device, wherein the transmitter device has the features of the transmitter of claim 44.

79. A transmitter-receiver arrangement as set forth in claim 78 which is in the form of a mobile terminal of a user and wherein the receiver device is adapted to receive from an associated base station information about a frequency band to be used for the transmission and to pass that information prior to transmission of symbols to the base station to the transmitter device.

80. A transmitter-receiver arrangement as set forth in claim 79 which is in the form of a base transceiver station of a mobile radio network.

81. A transmitter-receiver arrangement as set forth in claim 78 wherein the receiver device is adapted to effect an RSSI measurement (radio signal strength indicator) of a power received from a second transmitter-receiver arrangement by way of a communication channel and to communicate to the transmitter device a signal which is dependent on the measurement result, and wherein the transmitter device is adapted to transmit a signal representative of the measurement result to the second transmitter-receiver arrangement.

82. A transmitter-receiver arrangement as set forth in claim 81 wherein the control unit of the transmitter device produces its control signals in dependence on the result of an RSSI measurement obtained from the second transmitter-receiver arrangement.

83. A receiver for carrying out the method as set forth in claim 1.
